(19) United States
(12) Patent Application Publication
(10) Pub. No.: US 2026/0087728 A1
(43) Pub. Date: Mar. 26, 2026

(54) METHOD AND A SYSTEM FOR GENERATING 3D SCENES

(71) Applicant: Y.E. Hub Armenia LLC, Yerevan (AM)

(72) Inventor: Sergei ELISEEV, Moscow (RU)

(21) Appl. No.: 19/333,303

(22) Filed: Sep. 18, 2025

(30) Foreign Application Priority Data
Sep. 20, 2024 (RU) 2024127865

(51) Int. Cl. G06T 15/08; G06T 7/70; G06T 15/20

(52) U.S. Cl. CPC G06T 15/08; G06T 7/70; G06T 15/20; G06T 2207/10024; G06T 2207/20081

(57) ABSTRACT

A method and server for volume rendering of 3D scenes are provided. The method comprises training a given machine-learning algorithm (MLA) of a plurality of MLAs to identify a boundary between a plurality of interpenetrated objects to be rendered in a given 3D scene, by applying a signed distance function (SDF) loss function configured to penalize a respective predicted SDF value, generated by the given MLA during a given training iteration, for a given point of a training 3D scene, in response to the respective predicted SDF value generated by the given MLA being equal to the respective predicted SDF value generated by an other MLA of the plurality of MLAs.

### CROSS-REFERENCE

The present application claims priority to Russian Patent Application No. 2024127865, entitled “Method and a System for Generating 3D Scenes”, filed Sep. 20, 2024, the entirety of which is incorporated herein by reference.

### FIELD

The present technology relates generally to the field of video processing, and more particular, to methods and systems for processing video content for generating 3D scenes.

### BACKGROUND

Generating 3D scenes from image sequences, for example, those defining a given video content may have a wide variety of applications in many fields, such as generating 3D maps for autonomous vehicles, navigation in robotics, or generating content for Virtual or Augmented Reality applications.

Generally, a video content representative of objects to be rendered in a given 3D scene is recorded, using a camera. Further, this video content is analyzed to identify therein the objects and, using approaches of volumetric rendering, generate 3D models of the objects and surrounding thereof.

Some video content may be representative of scenes including closely interacting objects (also referred to herein as “interpenetrating objects”) such that at least portions thereof overlap or occlude each other. For example, this video content can be representative of a boxing fight or a soccer game, during which the represented individuals can be touching each other, such as with their limbs, forming contact surfaces therebetween. Given such a close interaction between the objects in the video content, it may be challenging to determine a boundary between them for tracking movement of the overlapped and/or occluded portions of the objects and generating a realistic 3D scene thereof.

Certain prior art approaches have been proposed to tackle the above-identified technical problem.

An article, entitled “Vid2Avatar: 3D Avatar Reconstruction from Videos in the Wild via Self-supervised Scene Decomposition,” authored by Guo et al., and published in the proceedings of 2023 IEEE/CVF Conference on Computer Vision and Pattern Recognition (CVPR) in June 2023, discloses a method to learn human avatars from monocular in-the-wild videos. More specifically, this method allows solving the tasks of scene decomposition and surface reconstruction directly in 3D by modeling both the human and the background in the scene jointly, parameterized via two separate neural fields. To do so, the method includes defining a temporally consistent human representation in canonical space and formulate a global optimization over the background model, the canonical human shape and texture, and per-frame human pose parameters. A coarse-to-fine sampling strategy for volume rendering and novel objectives are used for a clean separation of dynamic human and static background, yielding detailed and robust 3D human reconstructions.

An article, entitled “Novel View Synthesis of Human Interactions From Sparse Multi-view Videos,” authored by Qing et al., and published in SIGGRAPH '22: ACM SIGGRAPH 2022 Conference Proceedings in July 2022, discloses a system for generating free-viewpoint videos of multiple human performers from very sparse RGB cameras. The system reconstructs a layered neural representation of the dynamic multi-person scene from multi-view videos with each layer representing a moving instance or static background.

An article, entitled “Fast Virtual View Synthesis for an 8 K 3D Light-Field Display Based on Cutoff-Nerf and 3D Voxel Rendering,” authored by Shuo et al., and published in Optics Express Vol. 30, Issue 24, pp. 44201-44217 in November 2022, discloses a two-stage virtual view synthesis method based on cutoff-NeRF and 3D voxel rendering, which can fast synthesize dense novel views with smooth parallax and 3D images with a resolution of 7680×4320 for the 3D light-field display. In the first stage, an image-based cutoff-NeRF is proposed to implicitly represent the distribution of scene content and improve the quality of the virtual view. In the second stage, a 3D voxel-based image rendering and coding algorithm is presented, which quantify the scene content distribution learned by cutoff-NeRF to render high-resolution virtual views fast and output high-resolution 3D images.

### SUMMARY

It is an object of the present technology to ameliorate at least some of the inconveniences present in the prior art.

Developers of the present technology have appreciated that a boundary between objects in each image of the image sequence of the video content that is used for generating the given 3D scene can be identified using specifically trained neural networks. According to at least some non-limiting embodiments of the present technology, a given neural network is trained to predict, for a given point in a given image of the image sequence, a value of a Signed Distance Field (SDF) defined around a respective object, that has been pre-associated with the given neural network.

The SDF around a given object in the given image is defined in such a way that if a given point of the given image is inside a contour of the given object, a respective SDF value in the given point equals a negative distance therefrom to the contour of the given object. Conversely, if the given point is outside the contour of the given object, the respective SDF value in the given point equals a positive distance therefrom to the contour of the given point.

Thus, as the neural networks are trained in concert, each neural network thereof is trained to predict, for the given point, an SDF value with respect to “its own” pre-associated object. Further, for more accurate identification of the boundary between at least two interpenetrated objects, the developers of the present technology have devised a specific loss function that is configured to penalize same predictions of the respective neural networks.

By doing so, occurrences where two given neural networks are predicting for the given point the same negative SDF value (that is, that the given point inside the contours of their pre-associated objects) can be minimized or even annihilated, allowing accurately determining within which object's contour the given point is disposed. Accordingly, based on the so identified points in the given image, the boundary between a pair of interpenetrated objects can be more accurately determined allowing for rendering a more accurate and realistic 3D scene.

Also, using the SDF values generated by the so trained neural networks, the developers of the present technology have developed a method for determining color values for the interpenetrated objects that are further used for the volume rendering of the given 3D scene.

More specifically, in accordance with a first broad aspect of the present technology, there is provided a computer-implemented method for volume rendering of 3D scenes. The method comprises training a given machine-learning algorithm (MLA) of a plurality of MLAs to identify a boundary between a plurality of interpenetrated objects to be rendered in a given 3D scene. The training comprises: receiving, from a given camera of a plurality of cameras, a respective sequence of training 2D images representative of a plurality of interpenetrated training objects; generating, using respective sequences of training 2D images from the plurality of cameras, a sequence of rectified training 2D images; generating, for a given training object of the plurality of interpenetrated training objects in a given rectified training 2D image of the sequence of rectified training 2D images, a respective Skinned-Multi Person Linear Model (SMPL) pose estimate, the respective SMPL pose estimate including: pose vertices defining a surface of the given training object in a respective pose thereof in the given rectified training 2D image; and a respective SMPL pose vector comprising values of a plurality of SMPL pose parameters representative of the respective pose of the given training object in the given rectified training 2D image; retrieving, for the given training object of the plurality of interpenetrated training objects, a canonical SMPL pose, the canonical SMPL pose including canonical vertices defining the surface of the given training object in a predetermined pose thereof; generating a closed 3D space around the respective SMPL pose estimates associated with the plurality of interpenetrated training objects; generating, along an inner surface of the closed 3D space, a plurality of viewpoints such that each one of the plurality of viewpoints is directed to a center of the closed 3D space; extending, from each viewpoint of the plurality of viewpoints, a respective plurality of rays through the respective SMPL pose estimates of the plurality of interpenetrated training objects; for a given point along a given ray, identifying a corresponding canonical point in the canonical SMPL pose associated with each one of the plurality of interpenetrated training objects; generating, for the given MLA of the plurality of MLAs, a respective training set of data, the respective training set of data including a plurality of training digital objects, a given one of which, for the given point along the given ray comprises: (i) coordinates of the corresponding canonical point associated with the respective training object; and (ii) the respective SMPL pose vector associated with the respective training object; using respective training sets of data, jointly training the plurality of MLAs to identify the boundary of the respective object of the plurality of interpenetrated objects, by: feeding respective training digital objects associated with the given point to each MLA of the plurality of MLAs, thereby causing each one of the plurality of MLAs to generate a respective predicted signed distance field (SDF)value for the corresponding canonical point; and applying an SDF loss function, the SDF loss function being configured to penalize the respective predicted SDF value of the given point generated by the given MLA in response to the respective predicted SDF value generated by the given MLA being equal to the respective predicted SDF value generated by an other MLA of the plurality of MLAs.

In some implementations of the method, the closed 3D space comprises a sphere defined around the given training 3D scene; and wherein each one of the plurality of viewpoints is disposed along an inner surface of the sphere

In some implementations of the method, the plurality of viewpoints comprises two oppositely facing viewpoints directed to a center of the closed 3D space.

In some implementations of the method, the respective plurality of rays from a given viewpoint of the plurality of viewpoints are equally spaced therebetween.

In some implementations of the method, the method further comprises identifying the given point along the given ray, the identifying comprises identifying, along the given ray, a plurality of points including a predetermined number of points uniformly distributed along the given ray.

In some implementations of the method, the identifying the corresponding canonical point comprises applying an SMPL-based Linear Blend Skinning algorithm.

In some implementations of the method, the applying is in accordance with a following equation:

$${x}^{c} = {( {\sum }_{i = 1}^{{n}_{b}} {w}_{i}^{d} {B}_{i} )}^{- 1} {x}^{d} ,$$

where x^{c} is the corresponding canonical point associated with the given training object;
   x^{d} is the given point along the given ray;
   Bᵢ is a transformation matrix associated with a joint jᵢ of the given training object, the transformation matrix having been generated based on the respective SMPL pose estimate associated with the given training object;
   n_{b} is a number of joints of the given training object; and
   w^{d}ᵢ is a function indicative of a weight distribution across a skinning process, the weight distribution having been determined based on coordinates of a respective vertex of the respective SMPL pose estimate associated with the given training object that is closest to the given point.

In some implementations of the method, the SDF loss function is expressed by a following equation:

$${L}_{SDF} = \frac{1}{( \begin{matrix}N \\ 2\end{matrix} )} {\sum }_{p = 1}^{P} {\sum }_{k = p + 1}^{P} {\sum }_{i = 1}^{N * P} \text{?} ( {s}_{i}^{k} , {s}_{i}^{p} ) {s}_{i}^{k} \cdot {s}_{i}^{p} ,$$

$$\text{?} \text{indicates text missing or illegible when filed}$$

where P is a number of training objects in the plurality of interpenetrated training objects;

$$( \begin{matrix}N \\ 2\end{matrix} )$$

is a number of unique pairs of training objects within the plurality of interpenetrated training objects;
sᵢ^{k} is the respective predicted SDF value for the given point generated by a first one of the plurality of MLAs, associated with a first training object of the plurality of interpenetrated training objects; and
sᵢ^{p} is the respective predicted SDF value for the given point generated by a second one of the plurality of MLAs, associated with a second training object of the plurality of interpenetrated training objects.

In some implementations of the method, the feeding respective training digital objects associated with the given point to each MLA of the plurality of MLAs further causes each one of the plurality of MLAs to generate a respective SDF vector embedding for the corresponding canonical point; the training the plurality of MLAs comprises training the plurality of MLAs in concert with training a second plurality of MLAs to determine color values for the plurality of interpenetrated objects to be rendered in the given 3D scene. The training the second plurality of MLAs comprises: receiving, at a current training iteration, from each one of the plurality of MLAs, respective predicted SDF values for the corresponding canonical point associated with the given point; determining, based on the respective predicted SDF values, current predicted density values for the corresponding canonical point; generating, for an other given MLA of the second plurality of MLAs, a respective other training set of data including an other plurality of training digital objects, a given one of which, for the given point along the given ray includes: (i) the coordinates of the corresponding canonical point associated with the respective training object associated with the other given MLA; (ii) the respective SDF vector embedding for the corresponding canonical point associated with the respective training object; and (iii) a respective label representative of a color value of a pixel of the given rectified training 2D image associated with the given ray; and feeding respective training digital objects from each respective other training set of data each MLA of the second plurality of MLAs associated with the given point, thereby causing each one of the second plurality of MLAs to generate a respective predicted color value for the corresponding canonical point associated with the respective training object; determining, based on respective predicted color values generated by each one of the second plurality of MLAs and the current predicted density values generated by the plurality of MLAs for each point of the given ray, a respective intermediate aggregated color value for the given ray at the current training iteration; and applying a color loss function, the color loss function being configured to penalize the respective intermediate aggregated color value in response to the respective intermediate color aggregation value being different from the color label of the respective label.

In some implementations of the method, the determining the respective intermediate aggregated color value comprises determining the respective aggregated color value according to a following equation:

$${C}_{r} = {\sum }_{p = 1}^{P} {\sum }_{i = 1}^{N * P} {w}_{i}^{p} \cdot {c}_{i}^{p} + {bg}_{r} ,$$

where c^{p}ᵢ is the respective predicted color value for the corresponding canonical point, associated with the respective object p generated by the given MLA of the second plurality of MLAs;
   w^{p}ᵢ is a respective weight value determined for the respective predicted color value based on the current predicted density values; and
   bgᵣ is a background color associated with the given ray.

In some implementations of the method, the method further comprises determining the respective weight value according to a following equation:

$${w}_{i}^{p} = ( 1 - exp ( Δ {x}_{i} {σ}_{i}^{p} ) ) \cdot exp ( - {\sum }_{j = 1}^{i} Δ {x}_{i} \cdot {\sum }_{k = 1}^{P} {σ}_{i}^{k} ) ,$$

where Δxᵢ is a length of a segment between the given point and a sequentially following point along the given ray; and
σ^{p}ᵢ is a given current predicted density value, generated by a respective MLA of the plurality of MLAs, associated with the given training object, based on the respective SDF value.

In some implementations of the method, the determining the current predicted density values for the corresponding canonical point comprises applying, to each one of the respective predicted SDF values, a scaled Laplace distribution's Cumulative Distribution Function.

In some implementations of the method, prior to the generating the respective other training set of data, the method further comprises sampling, in the plurality of points of the given ray, a set of points for training the second plurality of MLAs within regions of a maximum density of the respective training object.

In some implementations of the method, the sampling comprises applying an importance sampling algorithm, the importance sampling algorithm being configured to generate, along the given ray, points representative of each one of the plurality of interpenetrated training objects through which the given ray extends.

In some implementations of the method, the method further comprises further comprising combining, along the given ray, points representative of each one of the plurality of interpenetrated training objects through which the given ray extends.

In some implementations of the method, the importance sampling algorithm comprises an opacity function.

In some implementations of the method, the method further comprises using the plurality of MLAs for identifying the boundary between the plurality of interpenetrated objects to be rendered in the given 3D scene. The using includes: receiving, from the given camera of the plurality of cameras, a respective in-use sequence of 2D images representative of the plurality of interpenetrated objects; generating, using respective in-use sequences of 2D images from the plurality of cameras, a sequence of in-use rectified 2D images; generating, for the given object of the plurality of interpenetrated objects in a given in-use rectified 2D image of the sequence of in-use rectified 2D images, a respective in-use SMPL pose estimate, the respective in-use SMPL pose estimate including: in-use pose vertices defining the surface of the given object in the respective pose thereof in the given in-use rectified 2D image; and the respective in-use SMPL pose vector comprising values of the plurality of SMPL pose parameters representative of the respective pose of the given object in the given in-use rectified 2D image; retrieving, for the given object of the plurality of interpenetrated objects, an in-use canonical SMPL pose, the in-use canonical SMPL pose including in-use canonical vertices defining the surface of the given object in the predetermined pose thereof; generating the closed 3D space around the respective in-use SMPL pose estimates associated with the plurality of interpenetrated objects, the closed 3D space including the plurality of viewpoints generated along the inner surface thereof; extending, from each viewpoint of the plurality of viewpoints, the respective plurality of rays through the respective in-use SMPL pose estimates; for the given point along the given ray, identifying a corresponding in-use canonical point for the in-use canonical SMPL pose associated with each one of the plurality of interpenetrated objects; generating, for the given MLA, associated with the respective object of the plurality of interpenetrated objects, a given in-use digital object, including: (i) coordinates of the in-use corresponding canonical point associated with the respective object; and (ii) the respective SMPL pose vector associated with the respective object; feeding the given in-use digital object to the given MLA of the plurality of MLAs, thereby causing the given MLA to determine a respective in-use SDF value for the corresponding canonical point; and based on respective in-use SDF values at the corresponding canonical point generated by each one of the plurality of MLAs, determining whether a surface of the given object extends through the given point.

In some implementations of the method, the feeding the given in-use digital object to the given MLA of the plurality of MLAs further causes the given MLA to generate a respective in-use SDF vector embedding for the corresponding canonical point associated with the respective object; and the using further comprises using the second plurality of MLAs for determining the color values for each one of the plurality of interpenetrated objects, by: determining, based on each respective in-use SDF value at the corresponding canonical point, generated by the plurality of MLAs, a respective density value at the corresponding canonical point; generating a given in-use color digital object including: (i) coordinates of the in-use corresponding canonical point associated with the respective object; and (ii) respective in-use SDF vector embedding for the corresponding canonical point; feeding, to the other given MLA of the second plurality of MLAs associated with the respective object, the given in-use color digital object, thereby causing the other given MLA to generate a respective color value for the corresponding canonical point of the respective object; determining, based on respective density values generated by the plurality of MLAs and respective color values generated by the second plurality of MLAs for the corresponding canonical point, a respective aggregated color value for the given ray; and using the respective aggregated color value for the volume rendering of the plurality of interpenetrated objects on the given 3D scene.

Further, in accordance with a second broad aspect of the present technology, there is provided a server for volume rendering of 3D scenes. The server comprises at least one processor and at least one non-transitory memory storing executable instructions, which, when executed by the at least one processor, cause the server to train a given machine-learning algorithm (MLA) of a plurality of MLAs to identify a boundary between a plurality of interpenetrated objects to be rendered in a given 3D scene, by: receiving, from a given camera of a plurality of cameras, a respective sequence of training 2D images representative of a plurality of interpenetrated training objects; generating, using respective sequences of training 2D images from the plurality of cameras, a sequence of rectified training 2D images; generating, for a given training object of the plurality of interpenetrated training objects in a given rectified training 2D image of the sequence of rectified training 2D images, a respective Skinned-Multi Person Linear Model (SMPL) pose estimate, the respective SMPL pose estimate including: pose vertices defining a surface of the given training object in a respective pose thereof in the given rectified training 2D image; and a respective SMPL pose vector comprising values of a plurality of SMPL pose parameters representative of the respective pose of the given training object in the given rectified training 2D image; retrieving, for the given training object of the plurality of interpenetrated training objects, a canonical SMPL pose, the canonical SMPL pose including canonical vertices defining the surface of the given training object in a predetermined pose thereof; generating a closed 3D space around the respective SMPL pose estimates associated with the plurality of interpenetrated training objects; generating, along an inner surface of the closed 3D space, a plurality of viewpoints such that each one of the plurality of viewpoints is directed to a center of the closed 3D space; extending, from each viewpoint of the plurality of viewpoints, a respective plurality of rays through the respective SMPL pose estimates of the plurality of interpenetrated training objects; for a given point along a given ray, identifying a corresponding canonical point in the canonical SMPL pose associated with each one of the plurality of interpenetrated training objects; generating, for the given MLA of the plurality of MLAs, a respective training set of data, the respective training set of data including a plurality of training digital objects, a given one of which, for the given point along the given ray comprises: (i) coordinates of the corresponding canonical point associated with the respective training object; and (ii) the respective SMPL pose vector associated with the respective training object; using respective training sets of data, jointly training the plurality of MLAs to identify the boundary of the respective object of the plurality of interpenetrated objects, by: feeding respective training digital objects associated with the given point to each MLA of the plurality of MLAs, thereby causing each one of the plurality of MLAs to generate a respective predicted signed distance field (SDF) value for the corresponding canonical point; and applying an SDF loss function, the SDF loss function being configured to penalize the respective predicted SDF value of the given point generated by the given MLA in response to the respective predicted SDF value generated by the given MLA being equal to the respective predicted SDF value generated by an other MLA of the plurality of MLAs.

In some implementations of the server, the feeding respective training digital objects associated with the given point to each MLA of the plurality of MLAs further causes each one of the plurality of MLAs to generate a respective SDF vector embedding for the corresponding canonical point; and the executable instructions cause the server to train the plurality of MLAs comprises training the plurality of MLAs in concert with training a second plurality of MLAs to determine color values for the respective object of the plurality of interpenetrated objects to be rendered in the given 3D scene, by: receiving, at a current training iteration, from each one of the plurality of MLAs, respective predicted SDF values for the corresponding canonical point associated with the given point; determining, based on the respective predicted SDF values, current predicted density values for the corresponding canonical point; generating, for an other given MLA of the second plurality of MLAs, a respective other training set of data including an other plurality of training digital objects, a given one of which, for the given point along the given ray includes: (i) the coordinates of the corresponding canonical point associated with the respective training object associated with the other given MLA; (ii) the respective SDF vector embedding for the corresponding canonical point associated with the respective training object; and (iii) a respective label representative of a color value of a pixel of the given rectified training 2D image associated with the given ray; and feeding respective training digital objects from each respective other training set of data each MLA of the second plurality of MLAs associated with the given point, thereby causing each one of the second plurality of MLAs to generate a respective predicted color value for the corresponding canonical point associated with the respective training object; determining, based on respective predicted color values generated by each one of the second plurality of MLAs and the current predicted density values generated by the plurality of MLAs for each point of the given ray, a respective intermediate aggregated color value for the given ray at the current training iteration; and applying a color loss function, the color loss function being configured to penalize the respective intermediate aggregated color value in response to the respective intermediate color aggregation value being different from the color label of the respective label.

In some implementations of the server, the executable instructions further cause the server to use the plurality of MLAs for identifying the boundary between the plurality of interpenetrated objects to be rendered in the given 3D scene, by: receiving, from the given camera of the plurality of cameras, a respective in-use sequence of 2D images representative of the plurality of interpenetrated objects; generating, using respective in-use sequences of 2D images from the plurality of cameras, a sequence of in-use rectified 2D images; generating, for the given object of the plurality of interpenetrated objects in a given in-use rectified 2D image of the sequence of in-use rectified 2D images, a respective in-use SMPL pose estimate, the respective in-use SMPL pose estimate including: in-use pose vertices defining the surface of the given object in the respective pose thereof in the given in-use rectified 2D image; and the respective in-use SMPL pose vector comprising values of the plurality of SMPL pose parameters representative of the respective pose of the given object in the given in-use rectified 2D image; retrieving, for the given object of the plurality of interpenetrated objects, an in-use canonical SMPL pose, the in-use canonical SMPL pose including in-use canonical vertices defining the surface of the given object in the predetermined pose thereof; generating the closed 3D space around the respective in-use SMPL pose estimates associated with the plurality of interpenetrated objects, the closed 3D space including the plurality of viewpoints generated along the inner surface thereof; extending, from each viewpoint of the plurality of viewpoints, the respective plurality of rays through the respective in-use SMPL pose estimates; for the given point along the given ray, identifying a corresponding in-use canonical point for the in-use canonical SMPL pose associated with each one of the plurality of interpenetrated objects; generating, for the given MLA, associated with the respective object of the plurality of interpenetrated objects, a given in-use digital object, including: (i) coordinates of the in-use corresponding canonical point associated with the respective object; and (ii) the respective SMPL pose vector associated with the respective object; feeding the given in-use digital object to the given MLA of the plurality of MLAs, thereby causing the given MLA to determine a respective in-use SDF value for the corresponding canonical point; and

In the context of the present specification, a “server” is a computer program that is running on appropriate hardware and is capable of receiving requests (for example, from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (for example, received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. This information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a schematic diagram of an example computer system for implementing certain non-limiting embodiments of systems and/or methods of the present technology;

FIG. 2 depicts a networked computing environment suitable for some implementations of certain non-limiting embodiments the present technology;

FIG. 3 depicts a schematic diagram of a given scene to be rendered by a server present in the networked computing environment of FIG. 2, in accordance with certain non-limiting embodiments of the present technology;

FIG. 4 depicts a schematic diagram a given training scene in a set-up for generating a training set of data for training a plurality of density machine-learning algorithms (MLAs) and a plurality of color MLAs, executed by the server present in the networked computing environment of FIG. 2, to render the given scene of FIG. 3, in accordance with certain non-limiting embodiments of the present technology;

FIG. 5 depicts a schematic diagram of a training 3D scene, including training Skinned Multi-Person Linear model (SMPL) pose estimates of training objects of the given training scene of FIG. 4, rendered based on 2D image data, representative of the training objects, generated in the set-up illustrated in FIG. 4, in accordance with certain non-limiting embodiments of the present technology;

FIG. 6 depicts a schematic diagram of a canonical SMPL pose of a given training object depicted in FIG. 4 in an SDF grid, in accordance with certain non-limiting embodiments of the present technology;

FIG. 7 depicts the given scene of FIG. 3 in a set-up for generating in-use digital objects for the pluralities of density and color MLAs executed by the server present in the networked computing environment of FIG. 2, in accordance with certain non-limiting embodiments of the present technology;

FIG. 8 depicts a schematic diagram of a 3D scene generated based on image data representative of the given scene of FIG. 3 in the set-up of FIG. 7, in accordance with certain non-limiting embodiments of the present technology;

FIG. 9 depicts a schematic diagram of the 3D scene of FIG. 8 including rendered 3D models representative of objects present in the given scene of FIG. 3, in accordance with certain non-limiting embodiments of the present technology; and

FIG. 10 depicts a flow chart of a method for training a given MLA of the pluralities of density and color MLAs, executed by the server present in the networked computing environment of FIG. 2, to render the 3D scene of FIG. 9, representative of the given scene of FIG. 3, in accordance with certain non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “graphics processing unit,” may be provided through the use of dedicated hardware as well as hardware capable of executing software in association with appropriate software. When provided by a processor, the functions may be provided by a single dedicated processor, by a single shared processor, and/or by a plurality of individual processors, some of which may be shared. In some embodiments of the present technology, the processor may be a general-purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random-access memory (RAM), and/or non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

### Computer System

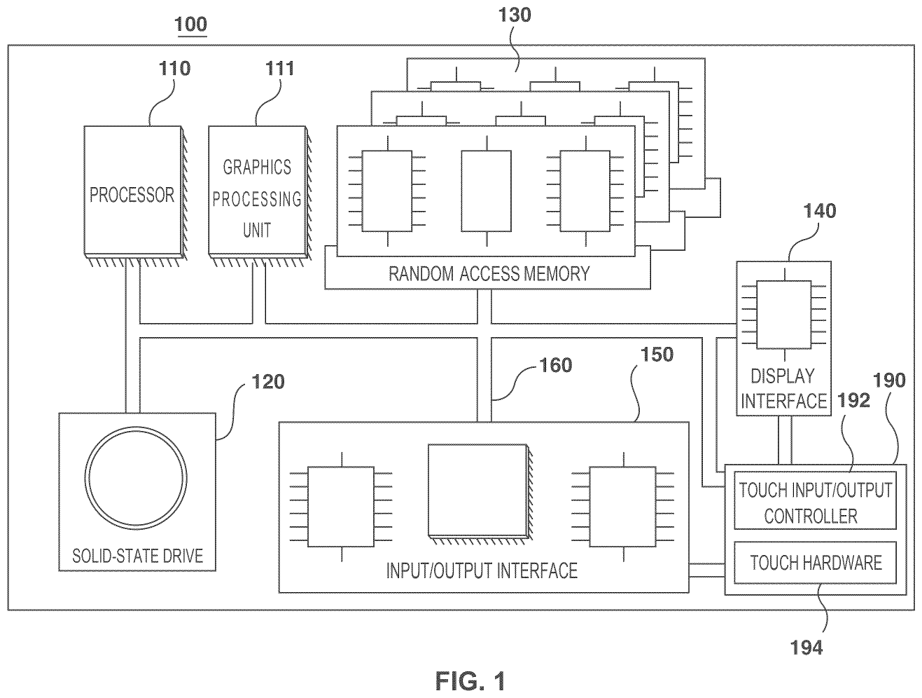

With reference to FIG. 1, there is depicted a computer system 100 suitable for use with some implementations of the present technology. The computer system 100 comprises various hardware components including one or more single or multi-core processors collectively represented by processor 110, a graphics processing unit (GPU) 111, a solid-state drive 120, a random-access memory 130, a display interface 140, and an input/output interface 150.

Communication between the various components of the computer system 100 may be enabled by one or more internal and/or external buses 160 (for example, a PCI bus, universal serial bus, IEEE 1394 “Firewire” bus, SCSI bus, Serial-ATA bus, etc.), to which the various hardware components are electronically coupled.

The input/output interface 150 may be coupled to a touchscreen 190 and/or to the one or more internal and/or external buses 160. The touchscreen 190 may be part of the display. In some embodiments, the touchscreen 190 is the display. In the embodiments illustrated in FIG. 1, the touchscreen 190 comprises touch hardware 194 (for example, pressure-sensitive cells embedded in a layer of a display allowing detection of a physical interaction between a user and the display) and a touch input/output controller 192 allowing communication with the display interface 140 and/or the one or more internal and/or external buses 160. In some embodiments, the input/output interface 150 may be connected to a keyboard (not shown), a mouse (not shown) or a trackpad (not shown) allowing the user to interact with the computer system 100 in addition to or instead of the touchscreen 190. In some embodiments, the computer system 100 may comprise one or more microphones (not shown). The microphones may record audio, such as user utterances. The user utterances may be translated to commands for controlling the computer system 100.

It is noted some components of the computer system 100 can be omitted in some non-limiting embodiments of the present technology. For example, the touchscreen 190 can be omitted, especially (but not limited to) where the computer system is implemented as a smart speaker device.

According to implementations of the present technology, the solid-state drive 120 stores program instructions suitable for being loaded into the random-access memory 130 and executed by the processor 110 and/or the GPU 111. For example, the program instructions may be part of a library or an application.

### Networked Computing Environment

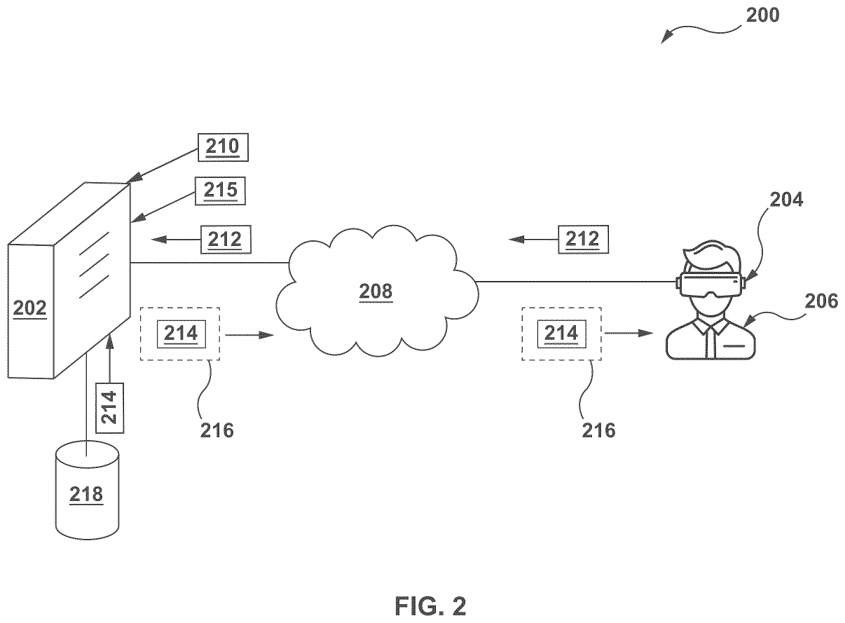

With reference to FIG. 2, there is depicted a schematic diagram of a networked computing environment 200 suitable for use with some embodiments of the systems and/or methods of the present technology. In some non-limiting embodiments of the present technology, the networked computing environment 200 can be configured to generating 3D scenes.

To that end, in some non-limiting embodiments of the present technology, the networked computing environment 200 comprises a server 202 communicatively coupled, via a communication network 208, to an electronic device 204. In the non-limiting embodiments of the present technology, the electronic device 204 may be associated with a user 206.

In some non-limiting embodiments of the present technology, the server 202 is implemented as a conventional computer server and may comprise some or all of the components of the computer system 100 of FIG. 1. In one non-limiting example, the server 202 is implemented as a Dell™ PowerEdge™ Server running the Microsoft™ Windows Server™ operating system but can also be implemented in any other suitable hardware, software, and/or firmware, or a combination thereof. In the depicted non-limiting embodiments of the present technology, the server 202 is a single server. In alternative non-limiting embodiments of the present technology (not depicted), the functionality of the server 202 may be distributed and may be implemented via multiple servers.

Further, the electronic device 204 may be any computer hardware that is capable of running a software appropriate to the relevant task at hand and can also comprise some or all components of the computer system 100 depicted in FIG. 1. Thus, some non-limiting examples of the electronic device 204 may include personal computers (desktops, laptops, netbooks, etc.), smartphones, and tablets.

In some non-limiting embodiments of the present technology, the electronic device 204 can be a head-mounted electronic device (also referred to herein as a head-mounted display, HMD). Broadly speaking, the head-mounted electronic device is an electronic device that is arranged to be worn over eyes of the user 206 and having, on a surface facing thereto, a display (also referred to herein as a “viewport”) configured for playing various video content that may be representative of various simulated environments. For example, in various non-limiting embodiments of the present technology, the head-mounted electronic device can be integrated in a helmet or glasses that the user 206 can put on over their eyes. Typically, the head-mounted electronic device comprises sensors configured to track movements of at least one of a body, a head, and pupils of the eyes of the user 206, data from which the head-mounted electronic device can be configured to use either to adjust parameters of a current video content or receive and play back an other video content, thereby providing the user 206 with simulated experience.

Further, in some non-limiting embodiments of the present technology, when worn over the eyes of the user 206, the head-mounted electronic device can be configured to fully block a vision of the user 206 providing thereto a simulated environment by playing back the respective video content. In these embodiments, the head-mounted electronic device can be referred to as a Virtual Reality (VR) head-mounted electronic device. In other non-limiting embodiments of the present technology, the head-mounted electronic device can be configured to block the vision of the user 206 only partially and play back such video content in the viewport of the head-mounted electronic device that would superimpose with an actual environment currently observed by the user 206. In these embodiments, the head-mounted electronic device can be referred to as an Augmented Reality (AR) head-mounted electronic device. Various applications of the head-mounted electronic device can include, without limitation, (1) video games, such as those where the user 206 is playing from the first-person perspective; (2) arts, for example, for conducting virtual tours to museums; and (3) medicine, such as for simulating surgical scenarios.

Specific examples of the head-mounted electronic device include, without limitation, a Meta™ Quest™ head-mounted electronic device, an Amazon™ OCuluS™ head-mounted electronic device, and an HTC™ Vive™ Pro head-mounted electronic device. Overall, in these embodiments, the electronic device 204 can be configured to play back an immersive VR or AR video content to the user 206.

Also, it should be expressly understood that the electronic device 204 can be one of a plurality of electronic devices, similar to the electronic device 204, which are communicatively coupled to the server 202, for playing back video content from the server 202.

In some non-limiting embodiments of the present technology, the video content to be reproduced by the electronic device 204 can be 3D animated video content comprising a 3D scene including animated 3D models of a plurality of objects. Types of objects that can be rendered in a given 3D scene are not limited and can include various movable and static objects. For example, the given 3D scene can be representative of a boxing fight; and the objects in the 3D scene can include boxers, a boxing ring, and at least a portion of an audience surrounding the boxing ring. In another example, the given 3D scene can be representative of a soccer game, and the objects represented in the given 3D scene can include soccer players and a ball. In yet another example, the given 3D scene can be representative of animals in their natural environment.

According to certain non-limiting embodiments of the present technology, the 3D animated video content for reproduction at the electronic device 204 can be provided by the server 202. Thus, in some non-limiting embodiments of the present technology, the server 202 can be under control of an entity producing certain video content for distribution thereof to end users via the communication network 208, such as the user 206. More specifically, in these embodiments, the server 202 can be used for composing and/or storing already generated 3D animated video content and cause transmission thereof to the electronic device 204, for example, upon a respective request therefrom. A format of the video content provided by the server 202 is also not limited can include, for example, MP4, MOV, and F4V.

Thus, according to certain non-limiting embodiments of the present technology, the electronic device 204 can be configured to transmit, over the communication network 208, a 3D animation request 212 to the server 202; and in response thereto, the server 202 can be configured to: (i) identify, in a database 218, a given 3D animated video content 214 responsive to the 3D animation request 212; (ii) compress the given 3D animated video content 214, thereby generating a compressed video data package 216; and (iii) transmit the compressed video data package 216 to the electronic device 204 for further presentation of the given 3D animated video content 214 to the user 206.

In some non-limiting embodiments of the present technology, the given 3D aminated video content 214 could be produced by the server 202. However, in other non-limiting embodiments of the present technology, any other third-party server rather than the server 202 could be configured for generating the given 3D animated video content 214 and transmit it to the server 202 for further storage and distribution to users of the communication network 208, such as the user 206.

It is not limited how the electronic device 204 can be configured to cause submission of the 3D animation request 212 to the server 202. In some non-limiting embodiments of the present technology, the 3D animation request 212 can be explicitly submitted by the user 206 using, for example, a corresponding actuator of a graphical user interface provided by the electronic device 204 for playing back the given 3D animated video content 214. Depending on a particular application of the electronic device 204, in these embodiments, the 3D animation request 212 can be indicative, for example, selecting the given 3D animated video content 214 from a catalogue of available content on the database 218 for playing back. In other non-limiting embodiments of the present technology, the user 206 can submit the 3D animation request 212 implicitly. For example, the user 206, wearing the electronic device 204 being the head-mounted electronic device mentioned above, can move his or her head, thereby causing rendering of another portion of a currently viewed 3D animated content.

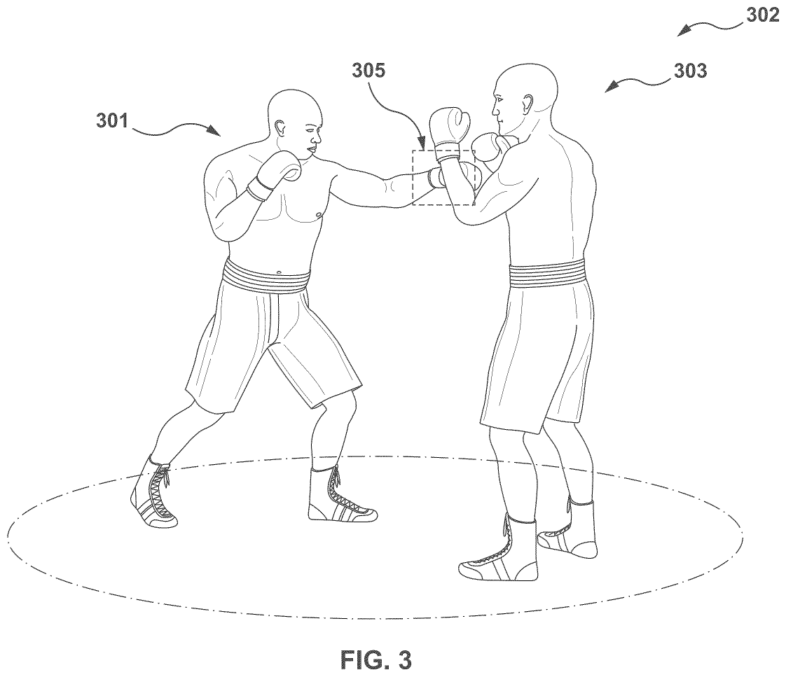

With reference to FIG. 3, there is depicted a schematic diagram of a given scene 302 to be rendered in the given 3D animated video content 214, in accordance with certain non-limiting embodiments of the present technology.

As it can be appreciated, in the present example, the given scene 302 to be reconstructed in the given 3D animated video content 214 includes two objects, that is, a first object 301 and a second object 303, which are in a current example are boxers during a boxing fight. However, as has been mentioned above, scenes representative of other events, including more than two objects, such as a soccer game or a dancing party, are also envisioned without departing from the scope of the present technology.

According to certain non-limiting embodiments of the present technology, the server 202 can be configured to generate the given 3D animated video content 214 representative of the given scene 302 using a respective 2D video content representative thereof. As will be described in greater detail below, the respective 2D video content can comprise at least one sequence of 2D images representative of the given scene 302, taken from a respective viewpoint. To convert the respective 2D video content into the given 3D animated video content 214, according to certain non-limiting embodiments of the present technology, the server 202 can be configured to apply a volume rendering algorithm. How the volume rendering algorithm can be implemented is not limited. For example, in some non-limiting embodiments of the present technology, the volume rendering algorithm can comprise a volume ray casting algorithm, which will be described in greater detail below.

One of the challenges associated with generating the 3D animated video content based on the respective 2D video content is that the objects in the scene, such as the first and second objects 301, 303, may have one or more overlap regions, such as an overlap region 305. In this regard, the first and second objects 301, 303 are referred to herein as “interpenetrated objects.” In other words, in the context of the present specification, the term “interpenetrated objects” denotes objects, portions of which either intersect with or occlude each other in a given 2D image representative of the objects.

For example, due to the overlap region 305, when the server 202 is producing the given 3D animated video content 214 including 3D models of the first and second objects 301, 303, the server 202 can fail to determine actual boundaries thereof, which can result in the server 202 applying improper textures, such as color values, to a 3D model of at least one of the first and second objects 301, 303 within the overlap region 305. More specifically, failing to determine that an arm of the second object 303 occludes an arm of the first object 301 may result in the server 202 generating the given 3D animated video content 214 where the portion of the arm of the second object 303 within the overlap region 305 is rendered having a texture and a color of a corresponding portion of the arm of the first object 301, that is, those of a boxing glove of the first object 301. In other words, failing to accurately determine the boundaries of the interpenetrated objects in the given scene 302 can cause the given 3D animated video content 214 to be rendered with errors and unrealistically, which may affect the user experience of the user 206 viewing the given 3D animated video content 214.

To address the identified technical problem, the developers of the present technology have developed methods and systems described herein that are directed to training a plurality of density machine-learning algorithms (MLAs) 210 to determine a signed distance function (SDF) value for vertices defining surfaces of the interpenetrated objects in the 3D scene to be rendered. To train the plurality of density MLAs 210, according to non-limiting embodiments of the present technology, the server 202 can be configured for using a specific loss function that is configured to penalize similar predictions of the plurality of density MLAs 210. According to certain non-limiting embodiments of the present technology, a given MLA of the plurality of MLAs is associated with a respective object of the interpenetrated objects in the given 3D scene 302 to be rendered. In the current example, there are two objects, the first and second objects 301, 303, in the given scene 302—therefore, the plurality of density MLAs 210 would include two MLAs, such that (i) a first density MLA of the plurality of density MLAs 210 is configured to determine the respective SDF value for a given point along the first object 301, and (ii) a second density MLA of the plurality of density MLAs 210 is configured to configured to determine the respective SDF value for the same, given, point within the second object 303.

In other words, the loss function is configured to penalize the prediction of the first and second MLAs that are representative of the given point being within each one of the first and second objects 301, 303 simultaneously. To do so, as will be described in detail hereinbelow, in some non-limiting embodiments of the present technology, the server 202 can be configured to train the plurality of density MLAs 210 jointly, that is, at the same time.

According to certain non-limiting embodiments of the present technology, a given density MLA of the plurality of density MLAs 210 can be implemented as a neural network. In a specific non-limiting example, the given density MLA of the plurality of MLAs 210 can comprise a multilayer perceptron (MLP). In this example, the given density MLA can be implemented as described in detail in an article entitled “Volume Rendering of Neural Implicit Surfaces,” authored by Yariv et al., and published at arxiv.org in December 2021, the content of which is incorporated herein by reference in its entirety.

Further, in some non-limiting embodiments of the present technology, based on the SDF values determined by the plurality of density MLAs 210, the server 202 can be configured to determine respective density values for the given point, which can be used for training a plurality of color MLAs 215 to determine color values for each one of the first and second objects 301, 303. In other words, akin to the plurality of density MLAs 210, each one of the plurality of color MLAs 215 is associated with the respective object in the given scene 302 to be rendered. In other words, in the present example, the plurality of MLAs 215 includes two color MLAs: (i) a first color MLA of the plurality of color MLAs 215 being configured to determine a respective color value for the given point along the first object 301, and (ii) a second color MLA of the plurality of color MLAs 215 being configured to determine the respective color value the same, given, point within the second object 303.

According to certain non-limiting embodiments of the present technology, the server 202 can also be configured to train the plurality of color MLAs 215 jointly. Furthermore, in some non-limiting embodiments of the present technology, the server 202 can be configured to train the plurality of density MLAs 210 in concert with training the plurality of color MLAs 215. More specifically, as will be described in detail below, the server 202 can be configured to generate current training input data for the given color MLA based on current training output data of the given density MLA.

Similar to the given density MLA, a given color MLA of the plurality of color MLAs can be implemented as a neural network.

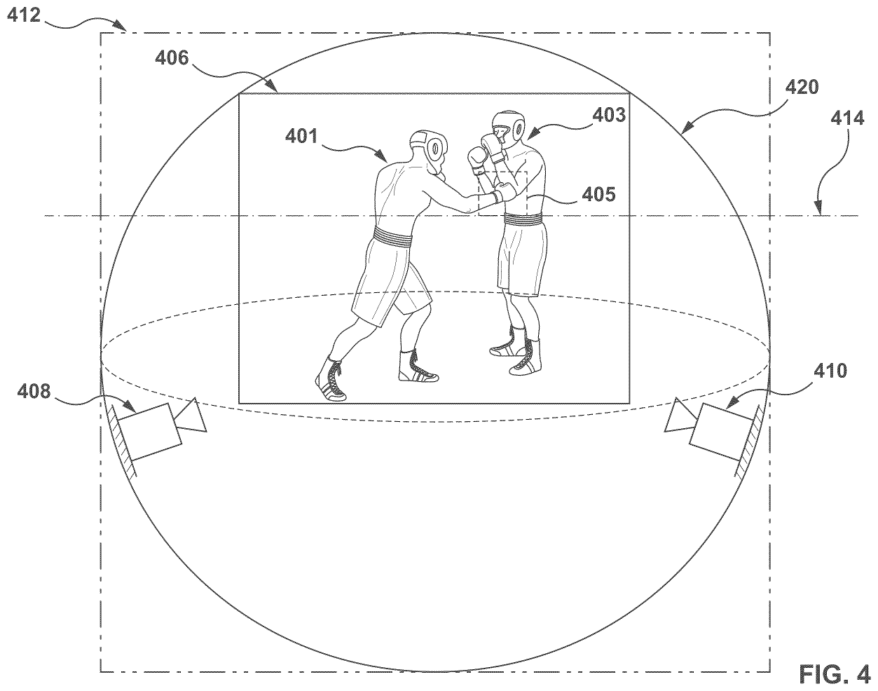

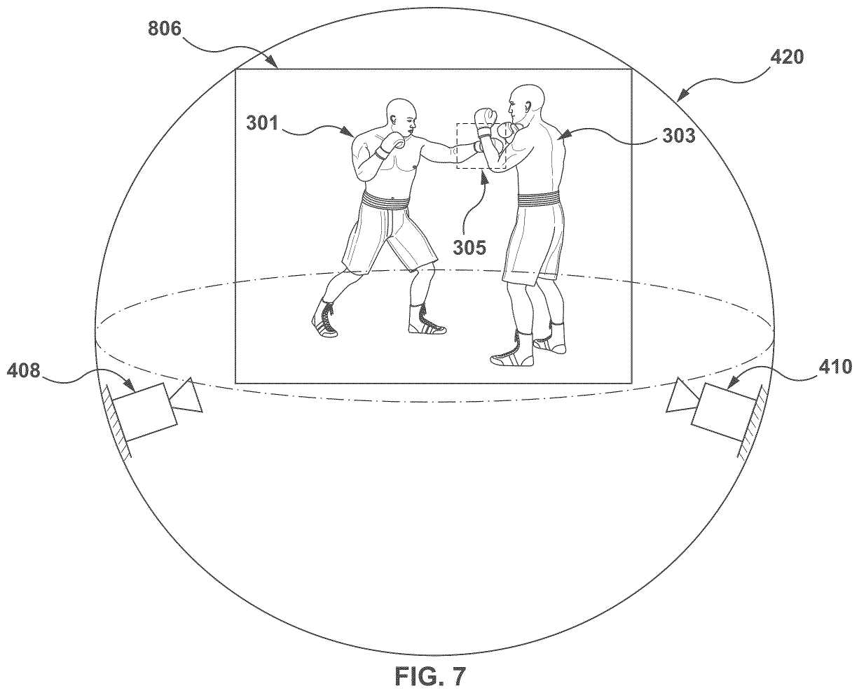

Generally speaking, the server 202 can be said to be executing two respective processes in respect of the plurality of density MLAs 210 and the plurality of color MLAs 215. A first process of the two processes is a training process, where the server 202 is configured to train the plurality of density and color MLAs 210, 215, based on a repetitive training set of data, to determine the respective SDF and color values for the given point, which will be discussed below with reference to FIGS. 4 to 6. A second process is an in-use process, where the server 202 executes the trained plurality of density and color MLAs 210, 215 to determine the respective SDF values and color values for in-use interpenetrated objects, such as the first and second objects 301, 303, which will be described below with reference to FIGS. 7 to 9.

Based on the so determined respective SDF values, according to certain non-limiting embodiments of the present technology, the server 202 can be configured to determine boundaries between the first and second objects 301, 303 within the overlap region 305 more accurately. This, in turn, can help more accurately train the plurality of color MLAs 215 to determine the color values for the first and second objects 301, 303, enabling to generate more realistic 3D renditions thereof.

### Communication Network

In some non-limiting embodiments of the present technology, the communication network 208 is the Internet. In alternative non-limiting embodiments of the present technology, the communication network 208 can be implemented as any suitable local area network (LAN), wide area network (WAN), a private communication network or the like. It should be expressly understood that implementations for the communication network 208 are for illustrative purposes only. How a respective communication link (not separately numbered) between each one of the server 202, the electronic device 204, and the communication network 208 is implemented will depend, inter alia, on how each one of the server 202 and the electronic device 204 is implemented. Merely as an example and not as a limitation, in those embodiments of the present technology where the electronic device 204 is implemented as a wireless communication device such as a smartphone, the communication link can be implemented as a wireless communication link. Examples of wireless communication links include, but are not limited to, a 3G communication network link, a 4G communication network link, and the like. The communication network 208 may also use a wireless connection with the server 202.

### Training Process

The training process commences with the server 202 generating the respective training sets of data for the pluralities of density and color MLAs 210, 215. To do so, the server 202 could be configured to acquire a training 2D video content representative of a plurality of training interpenetrated objects.

With reference to FIG. 4, there is schematically depicted a given training scene 402 to be rendered in a set-up for generating the training set of data for training the plurality of density MLAs 210 and the plurality of color MLAs 215, in accordance with certain non-limiting embodiments of the present technology.

As it can be appreciated, akin to the given scene 302, the given training scene 402 includes two interpenetrated objects, that is, a first training object 401 and a second training object 403 forming therebetween a training overlap region 405. Although similar to the given scene 302, the first and second training objects 401, 403 are also boxers, it must be expressly understood this similarity is used solely for the purposes of clarity and simplicity of explanations of the present technology, and in some non-limiting embodiments of the present technology, the given training scene 402 can be representative of other events, including other objects, such as soccer players during a soccer match, dancers, and so on.

According to certain non-limiting embodiments of the present technology, the training 2D video content for generating the training set of data has been produced by cameras that recorded the given training scene 402, such as first camera 408 and a second camera 410. In some non-limiting embodiments of the present technology, the first and second cameras 408, 410 can be disposed at opposite ends of the given training scene 402. It should be understood that a number of cameras used for generating the training 2D video content is not limited and can include, for example, only one of the first and second cameras 408, 410, or more than two cameras, such as three, five, or ten cameras that are disposed around the given training scene 402.

How a given camera of the first second cameras 401, 403 is implemented is not limited; and in some non-limiting embodiments of the present technology can include a complementary metal-oxide-semiconductor (CMOS) image sensor configured to generate image sequences that are suitable for a desired playback speed, such as 24 frames per second (FPS), 48 FPS, or 72 FPS.

In a specific non-limiting example, the given camera can be implemented based on a CMOS image sensor of a type available from Sony Semiconductor Solutions Corporation of 4-14-1 Asahi-cho, Atsugi-shi, Kanagawa, 243-0014, Japan. It should be expressly understood that the given camera can be implemented using any other suitable equipment.

Further, according to certain non-limiting embodiments of the present technology, each one of the first and second cameras 408, 410 could be disposed within the given training scene 402 along an inner surface of an imaginary sphere 420 such that each one of the first and second cameras 408, 410 is directed to a center (not depicted) of the imaginary sphere 420, while the first and second training objects 401, 403 are disposed on one of cross-sections of the imaginary sphere 420. Dimensions of the imaginary sphere 420 are not limited; and in some non-limiting embodiments of the present technology, the imaginary sphere 420 can have a diameter of 4 meters, for example.

Thus, according to certain non-limiting embodiments of the present technology, each one of the first and second cameras 408, 410 can be configured to generate a respective sequence of training 2D images representative of the given training scene 402 from a corresponding perspective of the given camera. In some non-limiting embodiments of the present technology, the first and second cameras 408, 410 could be synchronized such that they generate corresponding training 2D images representative of the given training scene 402 at a same moment in time.

Further, in some non-limiting embodiments of the present technology, the server 202 can be configured to receive respective sequences of training 2D images directly from each one of the first and second cameras 408, 410 via wired or wireless communication link. In other non-limiting embodiments of the present technology, the sequences of training 2D images can be aggregated on a third-party server (not depicted), with which the server 202 is communicatively coupled, or a portable storage receivable in the server 202.

Further, once the server 202 has received the respective sequences training 2D images representative of the given training scene 402 generated by each one of the first and second cameras 408, 410, according to certain non-limiting embodiments of the present technology, the server 202 can be configured to generate, based on the respective sequences of training 2D images, a sequence of rectified training 2D images. To do so, according to certain non-limiting embodiments of the present technology, the server 202 can be configured to project corresponding training 2D images from each one the respective sequences of training 2D images onto a common plane 412 that extends in parallel to a baseline 414.

Using each rectified training 2D image of the so generated plurality of rectified training 2D images, such as a given rectified training 2D image 406, the server 202 can be configured to generate the training set of data. In this regard, according to certain non-limiting embodiments of the present technology, the server 202 can be configured to analyze the given rectified training 2D image 406 by applying thereto a semantic segmentation model (not depicted). For example, the server 202 could be configured to access the semantic segmentation model via the communication network 208. According to certain non-limiting embodiments of the present technology, the semantic segmentation model can be pre-trained to classify each pixel of the given rectified training 2D image 406 into one or more object, such as one of the first and second training objects 401, 403 or a background. It is not limited how the semantic segmentation model can be implemented; and in some non-limiting embodiments of the present technology, the semantic segmentation model can comprise a convolutional neural network (CNN).

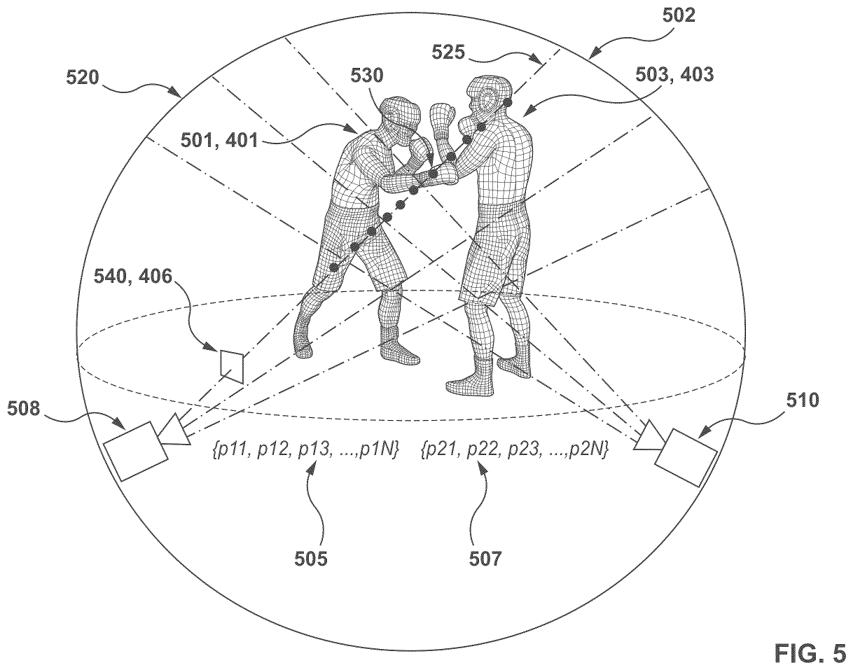

Further, according to certain non-limiting embodiments of the present technology, based on the given rectified training 2D image 406, the server 202 can be configured to generate a training 3D scene. With reference to FIG. 5, there is depicted a schematic diagram of a training 3D scene 502 generated based on the given rectified training 2D image 406, in accordance with certain non-limiting embodiments of the present technology.

According to certain non-limiting embodiments of the present technology, based on the object classes determined for each pixel of the given rectified training 2D image 406, according to certain non-limiting embodiments of the present technology, the server 202 can be configured to generate, for each one of the first and second training objects 401, 403, a respective training Skinned Multi-Person Linear model (SMPL) pose estimate, such as a first training SMPL pose estimate 501 for the first training object 401; and a second training SMPL pose estimate 503 for the second training object 403.

Broadly speaking, a given SMPL pose estimate of the first and second training SMPL pose estimates 501, 503, such as the first training SMPL pose estimate 501 comprises mesh elements (such as triangular mesh elements, for example) including a plurality of vertices, which define a surface of the first training object 401 in a pose thereof captured by the given rectified training 2D image 406. Also, in some non-limiting embodiments of the present technology, each one of the first and second training SMPL pose estimates 501, 503 can include a respective training SMPL pose vector, that is, a first training SMPL pose vector 505 and a second training SMPL pose vector 507.

According to certain non-limiting embodiments of the present technology, a given one of the first and second training SMPL pose vectors 505, 507, such as the first training SMPL pose vector 505, includes pose and shape parameters associated with the first training object 401 and are representative of the pose and shape of the first training object 401 captured by the given rectified training 2D image 406. More specifically, in the embodiments where the first training object 401 is a human being, the pose parameters of the first training SMPL pose vector 505 includes parameters representative of relative rotations of joints of the human being in the pose captured by the given rectified training 2D image 406. In some non-limiting embodiments of the present technology, the pose parameters can include sixty-nine parameters. The shape parameters are representative of an amount of expansion or shrinking of the first training object 401 in the given rectified training 2D image 406 along a plurality of predetermined directions. For example, a given predetermined direction of the plurality of predetermined directions can be along a longitudinal axis of the first training object 401, extending along a spinal cord thereof, and respective shape parameters along the given predetermined directions can be representative of an extent the first training object 401 in the given rectified training 2D image 406 being tall or short, as an example. In some non-limiting embodiments of the present technology, the shape parameters can include ten parameters.

According to certain non-limiting embodiments of the present technology, to generate the first and second training SMPL pose estimates 501, 503 for the first and second training objects 401, respectively, the server 202 could be configured to apply, to the given rectified training 2D image 406 including the classified pixels thereof, an SMPL EasyMocap framework-based algorithm. However, use of any other suitable algorithm is also envisioned.

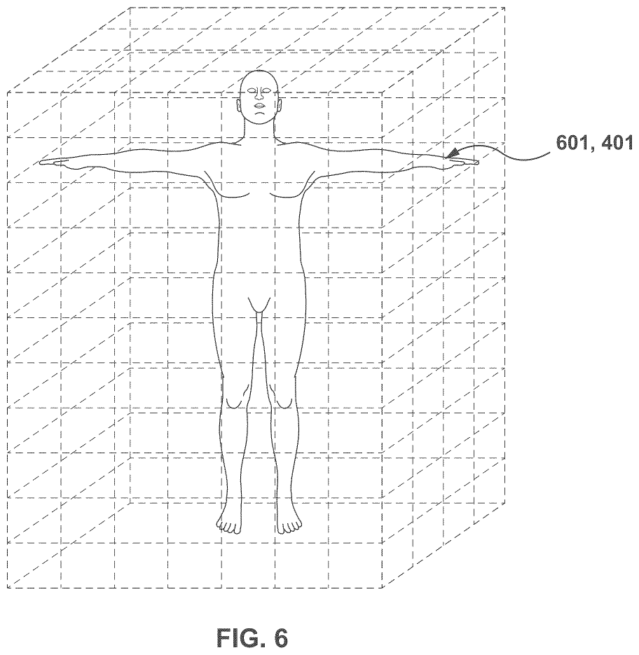

In some non-limiting embodiments of the present technology, as will become apparent from the description provided hereinbelow, the server 202 can be configured to generate (or otherwise receive), for each one of the first and second training objects 401, 403, a respective training canonical SMPL pose, such as a first training canonical SMPL pose 601 for the first training object 402 schematically depicted in FIG. 6, in accordance with certain non-limiting embodiments of the present technology.

Similar to the first training SMPL pose estimate 501, the first training canonical SMPL pose 601 can comprise mesh elements including vertices defining the surface of the first training object 401 but, unlike the first training SMPL pose estimate 501, the vertices of the first canonical SMPL pose estimate 601 represents the surface of the first training object 401 in a predetermined pose thereof. In the embodiments illustrated in FIG. 6, the predetermined pose of the first training object 401 can be a so called “T” pose thereof, that is, an upright standing position with arms being stretch out sideways in parallel to a support surface of the first training object 401.

In some non-limiting embodiments of the present technology, to generate the first canonical SMPL pose estimate 601, the server 202 can be configured to apply a trained SMPL MLA (not depicted) to which the server 202 can be configured to have access, for example, via the communication network 208. Broadly speaking, the trained SMPL MLA can be trained, either by the server 202 or by any other third-party server, to generate canonical SMPL pose estimates based on linear combinations of SMPL pose vectors representative of artist-created SMPL poses of various objects in desired poses thereof, such as the predetermined pose of the first training object 401 mentioned above. According to certain non-limiting embodiments of the present technology, the SMPL pose vectors can be generated in a similar manner to the first and second training SMPL pose vectors 505, 507 and thus include the shape and pose parameters of the artist-created SMPL poses. In a specific non-limiting example, the trained SMPL MLA can be implemented and trained as described in an article entitled “SMPL: A Skinned Multi-Person Linear Model,” authored by Loper et al. and published in ACM Transactions on Graphics (TOG), Volume 34 in October 2015. It should be expressly understood that other MLAs trained for generating canonical SMPL poses are also envisioned.

In some non-limiting embodiments of the present technology, the server 202 can be configured to retrieve the first training canonical SMPL pose 601 for the first training object 401 from a reference library of canonical SMPL poses that can be hosted on a third-party server (not depicted) communicatively coupled to the communication network 208.

As it can be appreciated, although not depicted, a second training canonical SMPL pose for the second training object 403 can be implemented and obtained, by the server 202, in a similar way to the first training canonical SMPL pose 601. Further, as will be described in detail below, the server 202 can be configured to use the first canonical SMPL pose 601 and the second training canonical SMPL pose for generating the training set of data for training the plurality of density MLAs 210.

With back reference to FIG. 5, to generate the training 3D scene 502, according to certain non-limiting embodiments of the present technology, the server 202 can be configured to define, around the first and second training SMPL pose estimates 501, 503 generated as described above, a closed 3D space 520. A form and dimensions of the closed 3D space 520 is not limited, and in some non-limiting embodiments of the present technology, the closed 3D space can correspond to the imaginary sphere 420 defined around the given training scene 402. In other words, in these embodiments, the closed 3D space 520 can also be a sphere defined around the first and second training SMPL pose estimates 501, 503 such that they are disposed on one of cross-sections of the sphere; while the dimensions of the sphere are defined by proportions between the dimensions of the imaginary sphere 420 and actual dimensions of the first and second training objects 401, 403.

Further, according to certain non-limiting embodiments of the present technology, the server 202 can be configured to generate, within the closed 3D space 520, a plurality of viewpoints onto the first and second training SMPL pose estimates 501, 503. In some non-limiting embodiments of the present technology, the server 202 can be configured to generate the plurality of viewpoints that correspond to the plurality of cameras used for producing the plurality of rectified training 2D images. For example, the server 202 can be configured to generate: (i) a first viewpoint 508 corresponding in position and orientation to the first camera 408; and a (ii) a second viewpoint 510 corresponding in position and orientation to the second camera 410. In other words, the server 202 can be configured to generate the first and second viewpoints 508, 510 that are disposed along an inner surface of the closed 3D space 520 and are directed to the center of the closed 3D space 520.

Further, according to certain non-limiting embodiments of the present technology, the server 202 can be configured to apply the ray casting algorithm. To do so, the server 202 can be configured to extend, from each one of the first and second viewpoints 508, 510, a respective plurality of rays, such as a given ray 525 cast from the first viewpoint 508.

In some non-limiting embodiments of the present technology, the server 202 can be configured to extend the respective plurality of rays from a given viewpoint of the first and second viewpoints 508, 510 such that rays are equally spaced therebetween within the respective plurality of rays. However, in other non-limiting embodiments of the present technology, the rays within the respective plurality of rays can be randomly spaced. Also, in some non-limiting embodiments of the present technology, a number of rays in the respective plurality of rays can depend on at least one of: a desired coverage of the first and second training SMPL pose estimates 501, 503 with rays; and a desired number of training digital objects in the training set of data for the pluralities of density and color MLAs 210, 215. In this regard, the number of rays for the respective plurality of rays can be selected based on trade-off between available computational resources of the server 202 and a desired accuracy of training the pluralities of density and color MLAs 210, 215. For example, in some non-limiting embodiments of the present technology, the server 202 can be configured to extend from each one of the first and second viewpoints 508, 510 the respective plurality of rays having 2048 rays.

Further, according to certain non-limiting embodiments of the present technology, the server 202 can be configured to define, along each ray extended from each one of the first and second viewpoint 508, 510, such as the given ray 525, a plurality of points—such as a given point 530. In some non-limiting embodiments of the present technology, the server 202 can be configured to define a same number of points along each one of a given plurality of rays. In some non-limiting embodiments of the present technology, the server 202 can be configured to define the plurality of points along the given ray 525 having a predetermined number of points. The predetermined number of points can be selected, akin to the number of rays, based on the trade-off between the available computational resources and the desired accuracy of training the pluralities of density and color MLAs 210, 215. In a specific non-limiting example, the server 202 can be configured to define 64 points along the given ray 525. However, in other non-limiting embodiments of the present technology, the server 202 can be configured to define 128, 256, or 1024 points along each ray of the respective pluralities of rays from each viewpoint.

In some non-limiting embodiments of the present technology, the server 202 can be configured to define the plurality of points evenly along the given ray 525. In other words, the server 202 can be configured to define the plurality of points to be equally spaced along the given ray 525.

Further, using the plurality of points along each ray extended from each viewpoint, such as the first and second viewpoints 508, 510, the server 202 can be configured to generate respective density training sets of data for training each one of the plurality of density MLAs 210 to identify the boundary between the first and second objects 301, 303.

In this regard, according to certain non-limiting embodiments of the present technology, the server 202 can be configured to identify, for the given point 530, in each one of the first training canonical SMPL pose 601 and the second training canonical SMPL pose associated with the first and second training objects 401, 403, a corresponding canonical point.

Further, according to certain non-limiting embodiments of the present technology, the server 202 can be configured to generate, for each density MLA of the plurality of density MLAs 210, a respective density training set of data. More specifically, for the first density MLA associated with the first training object 401, the server 202 can be configured to generate a first density training set of data that includes a first plurality of density training digital objects, a given density training digital object of which includes: (i) coordinates of the corresponding canonical point in a coordinate system (not depicted) associated with the first training canonical SMPL pose 601; and (ii) the first training SMPL pose vector 505.

Similarly, for the second density MLA of the plurality of density MLAs 210, the server 202 can be configured to generate a second density training set of data including a second plurality of density training digital objects, a given one of which, for the given point 530 includes: (i) coordinates of the corresponding canonical point in a coordinate system (not depicted) associated with the second training canonical SMPL pose associated with the second training object; and (ii) the second training SMPL pose vector 507.

It is not limited how the server 202 can be configured to identify the corresponding canonical points in each canonical SMPL poses, and in some non-limiting embodiments of the present technology, the server 202 can be configured to determine the corresponding canonical point, for example, in the first training canonical SMPL pose 601 by applying an SMPL-based Linear Blend Skinning algorithm. More specifically, in these embodiments, the server 202 can be configured to identify the corresponding canonical point, in accordance with a following equation:

$${x}^{c} = {( {\sum }_{i = 1}^{{n}_{b}} {w}_{i}^{d} {B}_{i} )}^{- 1} {x}^{d} , \qquad ( 1 )$$

where x^{c} is the corresponding canonical point associated with the respective training object;
x^{d} is the given point 530 along the given ray 525;
Bᵢ is a transformation matrix associated with a joint jᵢ of the first training object 401, the transformation matrix having been generated based on the first SMPL pose estimate 501;
n_{b} is a number of joints of the first training object 401; and
w^{d}ᵢ is a function indicative of a weight distribution across a skinning process, the weight distribution having been determined based on coordinates of a respective vertex of the first SMPL pose estimate 501 that is closest to the given point.

According to certain non-limiting embodiments of the present technology, during a given training iteration, the server 202 can be configured to feed density training digital objects associated with the given point 530 to a respective one of the plurality of density MLAs 210, thereby causing each density MLA of the plurality of density MLAs 210 to generate a respective predicted SDF value for their corresponding canonical points associated with the respective ones of the first and second training objects 401, 403. In other words, during the given training iteration, the server 202 is configured to: (1) feed the given density training digital object of the first plurality of density training digital objects to the first density MLA, thereby causing the first density MLA to generate a first predicted SDF value for the corresponding canonical point in the first training canonical SMPL pose 601; and (2) feed the given density training digital object of the second plurality of density training digital objects to the second density MLA, thereby causing the second density MLA to generate a second predicted SDF value for the corresponding canonical point in the second training canonical SMPL pose.

As will become apparent from the description provided hereinbelow, in some non-limiting embodiments of the present technology, in response to receiving the given density training digital object, each one of the plurality pf density MLAs 210 can further be configured to generate a respective SDF vector embedding for their corresponding canonical point. In other words, the first density MLA can be configured to generate, along with the first predicted SDF value, a first SDF vector embedding for the corresponding canonical point of the given point 530 in the first training canonical SMPL pose 601. Similarly, the second density MLA can be configured to generate, along with the second predicted SDF value, a second SDF vector embedding for the corresponding canonical point of the given point 530 in the second training canonical SMPL pose.

Further, to train the plurality of density MLAs 210, the server 202 can be configured to apply an SDF loss function. According to certain non-limiting embodiments of the present technology, the SDF loss function is configured to penalize at least one of the first and second predicted SDF values in response to the respective predicted SDF value generated by a given density MLA being equal to the respective predicted SDF value generated by an other density MLA of the plurality of MLAs. In some non-limiting embodiments of the present technology, the SDF loss function is configured to penalize the at least one of the first and second predicted SDF values in response to both the respective predicted SDF values generated by the given density MLA and by the other density MLA of the plurality of density MLAs 210 being negative.

In some non-limiting embodiments of the present technology, the SDF loss function can be expressed by a following equation:

$${L}_{SDF} = \frac{1}{( \begin{matrix}N \\ 2\end{matrix} )} {\sum }_{p = 1}^{P} {\sum }_{k = p + 1}^{P} {\sum }_{i = 1}^{N * P} \text{?} ( {s}_{i}^{k} , {s}_{i}^{p} ) {s}_{i}^{k} \cdot {s}_{i}^{p} , \qquad ( 2 )$$

$$\text{?} \text{indicates text missing or illegible when filed}$$

where P is a number of training objects, which, in the present example, equals two;

$$( \begin{matrix}N \\ 2\end{matrix} )$$

is a number of unique pairs of training objects;
sᵢ^{k} is the first predicted SDF value for the corresponding canonical point to the given point 530 in the first training canonical SMPL pose 601, generated by the first density MLA;
   sᵢ^{p} is the second predicted SDF value for the corresponding canonical point to the given point 530 in the second training canonical SMPL pose, generated by the second density MLA.

By feeding respective ones from the first and second pluralities of density training digital objects and further applying the above SDF loss function during each training iteration, the server 202 can be configured to train each one of the first and second density MLAs of the plurality of density MLAs 210 to determine SDF values for the first and second objects 301, 303. In some non-limiting embodiments of the present technology, after training the first and second density MLAs of the plurality of density MLAs 210, the server 202 can be configured to use the first and second density MLAs to determine the SDF values for the first and second objects 301, 303 for further identifying the boundary therebetween, as will be described below.

In other non-limiting embodiments of the present technology, the server 202 can be configured to continue the training process by using current predictions of the plurality of density MLAs 210 generated by the given training iteration for training the plurality of color MLAs 215.

Similar to training the plurality of the density MLAs 210, the server 202 can be configured to generate, for each one color MLA the plurality of color MLAs 215, a respective color training set of data. More specifically, for the first color MLA associated with the first training object 401, the server 202 can be configured to generate a first color training set of data that includes a first plurality of color training digital objects, a given color training digital object of which, for the given point 530, includes: (i) coordinates of the corresponding canonical point of the first training canonical SMPL pose 601; (ii) the first SDF vector embedding generated by the first density MLA; and (iii) the respective label comprising a color value of a respective pixel 540 of the given rectified training 2D image 406 through which the given ray 525 extends. In some non-limiting embodiments of the present technology, the given color training digital object of the first plurality of color training digital objects can further include: (iii) the first training SMPL pose estimate 501 second training canonical SMPL pose; (iv) normals to a surface of the first training canonical SMPL pose 601. In some non-limiting embodiments of the present technology, the server 202 can be configured to determine the normals to the surface of the first training canonical SMPL pose 601 as gradients of the respective SDF values determined by the plurality of density MLAs 210.

Similarly, for training the second color MLA of the plurality of color MLAs 215, associated with the second training object 403, the server 202 can be configured to generate a second color training set of data including a second plurality of color training digital objects, a given color training digital object of which, for the given point 530, includes: (i) coordinates of the corresponding canonical point along the second training canonical SMPL pose; (ii) the second SDF vector embedding generated by the second density MLA; and (iii) the respective label comprising the color value of the respective pixel 540 of the given rectified training 2D image 406 through which the given ray 525 extends. In some non-limiting embodiments of the present technology, the given color training digital object of the second plurality of color training digital objects can further include: (iii) the second training SMPL pose estimate 503 second training canonical SMPL pose; (iv) normals to a surface of the second training canonical SMPL pose. Similarly, in some non-limiting embodiments of the present technology, the server 202 can be configured to determine the normals to the surface of the second training canonical SMPL pose as gradients of the respective SDF values determined by the plurality of density MLAs 210.

In some non-limiting embodiments of the present technology, prior to generating the respective color training set of data for each color MLA of the plurality of color MLAs 215, the server 202 can be configured to sample a set of points from the plurality of points defined along the given ray 525 for generating the respective color training sets of data. According to certain non-limiting embodiments of the present technology, the server 202 can be configured to identify, in the plurality of points defined along the given ray 525, the set of points such that points thereof are located within higher-density regions of points along the given ray 525. In other words, to sample the set of points along the given ray 525, the server 202 can be configured to identify those of the plurality of points along the given ray 525 that are representative of the first and second training objects 401, 403 (that is, those that lie along the first and second training SMPL pose estimates 501, 503) and filter out those points of the plurality of points that are representative of a background.

According to certain non-limiting embodiments of the present technology, the server 202 can be configured to identify the set of points along the given ray 525 for generating the respective color training sets of data based on respective density values for each one of the plurality of points. In some non-limiting embodiments of the present technology, the server 202 can be configured to determine the respective density values based on the respective predicted SDF values generated, by the plurality of density MLAs 210, for corresponding canonical points of the first and second training objects 401, 403 that are associated with each point of the plurality of points defined along then given ray 525, such as the given point 530. To do so, according to certain non-limiting embodiments of the present technology, the server 202 can be configured to apply, to the respective predicted SDF values associated with the given point 530, a scaled Laplace distribution's Cumulative Distribution Function. Further, based on the so determined respective density values for the given point 530, the server 202 can be configured either to include the given point 530 to the set of points of the given ray 525 or reject the given point 530 from including to the set of points. For example, in some non-limiting embodiments of the present technology, the server 202 can be configured to: (i) determine an average density value for the given point 503 based of the respective density values for the corresponding canonical points; (ii) compare the average density value to a predetermined density threshold value; and (iii) in response to the average density value being equal to or greater than the predetermined density threshold value, the server 202 can be configured to include the given point 530 to the set of points for further generating the respective color training sets of data for training the plurality of color MLAs 215.

In other non-limiting embodiments of the present technology, the server 202 can be configured to apply, to the respective density values associated with the given point 530, an importance sampling algorithm. In some non-limiting embodiments of the present technology, the importance sampling algorithm can be implemented as an opacity function as described in detail, for example, in the article by Yariv et al. referenced above.

Broadly speaking, the importance sampling algorithm is configured to generate, based on the respective density values generated based on the SDF values determined using the plurality of density MLAs 210, more points along the given ray 525 representative of each one of the first and second training SMPL pose estimates 501, 503. Further, according to certain non-limiting embodiments of the present technology, the server 202 can be configured to combine points generated along the given ray 525 for each one of the first and second training SMPL pose estimates 501, 503 for further determining therein respective values as will be described in detail immediately below.

Further, during a subsequent training iteration, after causing the plurality of density MLAs 210 to generate the respective predicted SDF values for each point along the given ray 525, according to certain non-limiting embodiments of the present technology, the server 202 can be configured to feed, to each one of the plurality of color MLAs 215, a respective color training digital object associated with the given point 530, thereby causing each one of the plurality of color MLAs to generate a respective predicted color value for the corresponding canonical point associated with the respective training object. More specifically, in response to receiving the given training color digital object of the first plurality of color training digital objects, the first color MLA can be configured to generate a first predicted color value for the corresponding canonical point associated with the first training object 401. Similarly, in response to receiving the given training color digital object of the second plurality of color training digital objects, the second color MLA can be configured to generate a second predicted color value for the corresponding canonical point associated with the second training object 403.

Further, according to certain non-limiting embodiments of the present technology, the server 202 can be configured to determine a combination of the respective predicted color values generated by the plurality of color MLAs 215 for each one of the plurality of points (or set of points sampled therefrom) defined along the given ray 525 during the subsequent training iteration to generate a respective intermediate aggregated color value for the given ray 525. For example, the server 202 can be configured to determine the respective intermediate aggregated color value as a sum of the respective predicted color values for the points defined along the given ray 525.

According to certain non-limiting embodiments of the present technology, the server 202 can be configured to determine the respective intermediate aggregated color value as a weighted sum, for example, in accordance with a following equation:

$${C}_{r} = {\sum }_{p = 1}^{P} {\sum }_{i = 1}^{N * P} {w}_{i}^{p} \cdot {c}_{i}^{p} + {bg}_{r} , \qquad ( 3 )$$

where c^{p}ᵢ is the respective predicted color value for the corresponding canonical point, associated with the respective object p generated by the given color MLA of the plurality of color MLAs 215;
   w^{p}ᵢ is a respective weight value determined for the respective predicted color value based on the respective predicted density values; and
   bgᵣ is a background color value associated with the given ray 525.

It is not limited how the server 202 can be configured to determine the background color value associated with then given ray 535; and in some non-limiting embodiments of the present technology, the server 202 can be to train and further use a dedicated background MLA. In a specific non-limiting example, the dedicated background MLA can be implemented and trained as described in detail in an article entitled “Vid2Avatar: 3D Avatar Reconstruction from Videos in the Wild via Self-supervised Scene Decomposition,” authored by Guo et al., and published at arxiv.org in February 2023, the content of which is incorporated herein by reference in its entirety.

According to certain non-limiting embodiments of the present technology, the server 202 can be configured to determine the respective weight value determined for the respective predicted color value, such as one of the first and second predicted color values associated with the given point 530 based on the respective predicted density values associated with the given point 530. In some non-limiting embodiments of the present technology, the server 202 can be configured to determine the respective weight value in accordance with the following equation:

$${w}_{i}^{p} = ( 1 - exp ( Δ {x}_{i} {σ}_{i}^{p} ) ) \cdot exp ( - {\sum }_{j = 1}^{i} Δ {x}_{i} \cdot {\sum }_{k = 1}^{P} {σ}_{i}^{k} ) , \qquad ( 4 )$$

where Δxᵢ is a length of a segment between the given point 530 and a sequentially following point along the given ray 525; and
   σ^{p}ᵢ is the respective predicted density value, determined based on the respective SDF value generated by a respective density MLA of the plurality of density MLAs 210, associated with the given training object p, such as one of the first and second training object 401, 403.

After determining the respective intermediate aggregate color value for the given ray 525 as described above, the server 202 can be configured to jointly train the plurality of color MLAs 215 by applying, during the subsequent training iteration, a color loss function that is configured to penalize the respective color predictions generated by each one of the plurality of color MLAs 215 for each point along the given ray 525 if the respective intermediate aggregated color value is different from the color value of the respective pixel 540 from the respective label of color training digital objects associated with the given ray 525. In a specific non-limiting example, the color loss function can comprise an RGB loss function as described in detail in the article by Guo et al. referenced above.

It should be expressly understood that a number of training digital objects for training the given density MLA of the plurality of density MLAs 210 and for training the given color MLAs of the plurality of color MLAs 215 is not limited, and based on other rectified training 2D images of the sequence of rectified training 2D images, the server 202 can be configured to generate thousands, tens of thousands, hundreds of thousands, or even millions training digital objects for training each MLA as described above with respect to the given rectified training 2D image 406.

Thus, by jointly applying the SDF loss function and the color loss function during a plurality of training iterations, according to certain non-limiting embodiments of the present technology, the server 202 can be configured to train the plurality of density MLAs 210 to determine the SDF values and the plurality of color MLAs 215 to determine the color values for in-use interpenetrated objects, such as the first and second objects 301, 303 schematically depicted in FIG. 3.

Also, in some non-limiting embodiments of the present technology where the server 202 is configured to jointly train the plurality of density MLAs 210 and the plurality of color MLAs 215, by applying the color loss function, the server 202 is configured to additionally train each one of the plurality of density MLAs 210 to determine the respective SDF values based on the respective labels of color digital training objects.

Further, the server 202 can be configured to use the plurality of density MLAs 210 and the plurality of color MLAs 215 for the volume rendering of the given scene 302 including the first and second objects 301, 303, which will be described immediately below.

### In-Use Process

According to certain non-limiting embodiments of the present technology, to use the plurality of density MLAs 210 and the plurality of color MLAs 215 for the volume rendering, the server 202 can be configured to generate in-use digital objects.

To do so, first, according to certain non-limiting embodiments of the present technology, the server 202 can be configured to receive at least one sequence of in-use 2D images representative of the given scene 302. According to certain non-limiting embodiments of the present technology, the at least one sequence of in-use 2D images representative of the given scene 302 can be generated in a similar fashion to generating sequences of training 2D images of the given training scene 402.

With reference to FIG. 7, there is schematically depicted the given scene 302 in the set-up of FIG. 4 that is used for generating in-use digital objects, in accordance with certain non-limiting embodiments of the present technology.

As it is best seen from FIG. 7, for generating respective sequences of in-use 2D images representative of the given scene 302, similar to generating sequences of training 2D images, the plurality of cameras including, for example, the first and second cameras 408, 410 can be disposed along the inner surface of the imaginary sphere 420 that has been defined around the given scene 302. Each one of the first and second cameras 408, 410 can be directed to the center of the imaginary sphere, similar to the set-up for the given training scene 402 described above with reference to FIG. 4.

Thus, the server 202 can be configured to receive: (i) a first sequence of in-use 2D images from the first camera 408, and (ii) a second sequence of in-use 2D images from the second camera 410. Further, similar to generating the sequence of training rectified 2D images, based on the first and second sequences of in-use 2D images representative of the given scene 302, according to certain non-limiting embodiments of the present technology, the server 202 can be configured to generate a sequence of rectified in-use 2D images representative of the given 3D scene 302.

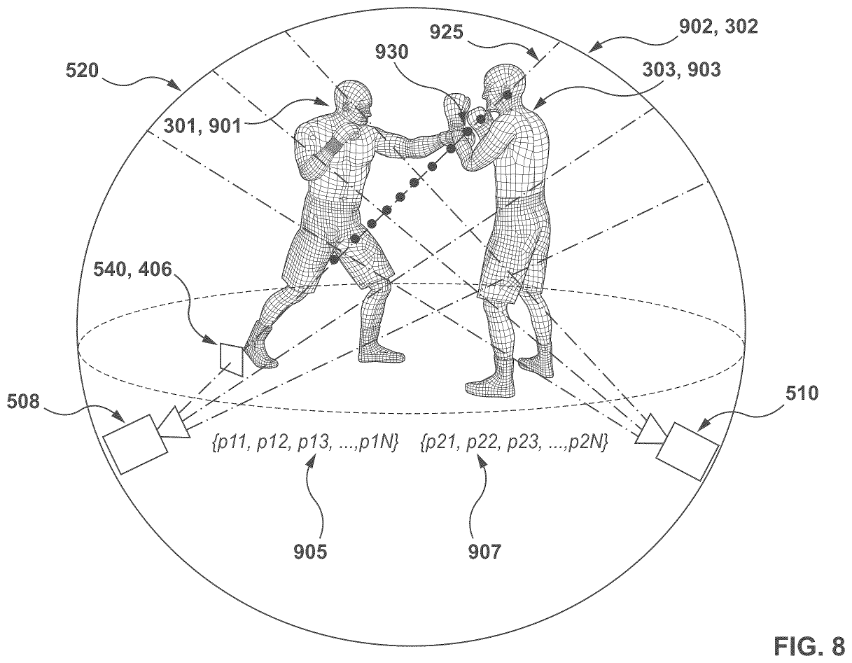

Further, based on a given in-use rectified 2D image 806 of the sequence of rectified in-use 2D images, the server 202 can be configured to generate: (i) a respective 3D scene (such as a 3D scene 902 depicted in FIG. 8); and (ii) based on the 3D scene 902, in-use digital objects for determining the boundary between the first and second objects 301, 302 in the 3D scene 902 as well as color values for points along the rays extending therewithin.

With reference to FIG. 8, there is depicted a schematic diagram of the 3D scene 902 generated based on the given rectified in-use 2D image 806, in accordance with certain non-limiting embodiments of the present technology.

According to certain non-limiting embodiments of the present technology, to generate 3D models of the first and second objects 301, 303, the server 202 can be configured to generate their respective in-use SMPL pose estimates. Similar to how the server 202 generated the first and second training SMPL pose estimates 501, 503 for the first and second training objects 401, 403, according to certain non-limiting embodiments of the present technology, based on the given in-use rectified 2D image 806, the server 202 can be configured to generate a first in-use SMPL pose estimate 901, including a first in-use SMPL pose vector 905, for the first object 301; and a second in-use SMPL pose estimate 903, including a second in-use SMPL pose vector 907, for the second object 303, capturing poses of the first and second objects 301, 303 as represented by the given in-use rectified 2D image 806.

Similarly to obtaining to the first training canonical SMPL pose 601 described above with reference to FIG. 6, according to certain non-limiting embodiments of the present technology, the server 202 can be configured to generate or otherwise retrieve, for each one of the first and second objects 301, 303, a first and second in-use canonical SMPL poses, respectively.

Further, as described above with reference to FIG. 5, the server 202 can be configured to define, around the first and second in-use SMPL pose estimates 901, 903, the closed 3D space 520 including the plurality of viewpoints, such as the first and second viewpoints 508, 510, disposed along the inner surface of the closed 3D space 520.

Similar to how it is described further above with reference to FIG. 5, the server 202 can be configured to: (i) extend, from each one of the first and second viewpoints 508, 510, a respective plurality of in-use rays; and (ii) define, along a given in-use ray 925, a plurality of in-use points, such a given in-use point 930.

Further, as described above with respect to the given point 530, the server 202 can be configured to identify, in the first and second in-use canonical SMPL poses, a first and second corresponding canonical points.

Further, the server 202 can be configured to generate, for each density MLA of the plurality of density MLAs 210 and each color MLA of the plurality of color MLAs 215 associated with the respective object, in-use digital objects. More specifically, the sever 202 can be configured to generate, for the first density MLA of the plurality of density MLAs 210 and the first color MLA of the plurality of color MLAs 215, associated with the first object 301, a first in-use digital object, including: (i) coordinates of the corresponding canonical point of the first in-use canonical SMPL pose associated with the first object 301 in a respective SDF grid; and (ii) the first in-use SMPL pose vector 905. Similarly, the sever 202 can be configured to generate, for the second density MLA of the plurality of density MLAs 210 and the second color MLA of the plurality of color MLAs 215, associated with the second object 303, a second in-use digital object, including: (i) coordinates of the corresponding canonical point of the second in-use canonical SMPL pose associated with the second object 303 in the respective SDF grid; and (ii) the second in-use SMPL pose vector 907.

Further, the server 202 can be configured to feed the first in-use digital object to: (i) the first density MLA, thereby causing the first density MLA to generate a first in-use SDF value for the corresponding canonical point along the first in-use canonical SMPL pose associated with the first object 301; and (ii) the first color MLA, thereby causing the first color MLA to generate a first in-use color value for the corresponding canonical point along the first in-use canonical SMPL pose associated with the first object 301. Similarly, the server 202 can be configured to feed the second in-use digital object to: (i) the second density MLA, thereby causing the second density MLA to generate a second in-use SDF value for the corresponding canonical point of the second in-use canonical SMPL pose associated with the second object 303; and (ii) the second color MLA, thereby causing the second color MLA to generate a second in-use color value for the corresponding canonical point of the first in-use canonical SMPL pose associated with the second object 303.

Further, based on the first and second in-use SDF values associated with the given point 930, the server 202 can be configured to determine whether the given point 930 is within one of the first and second in-use SMPL pose estimates 901, 903. Based on this determination, the server 202 can further be configured to determine a boundary between the first and second objects 301, 303 within the overlap region 305.

Further, to determine a final color value for the first and second in-use SMPL pose estimates 901, 903, the server 202 can be configured to determine a respective aggregate color value for the given ray 925. To do so, the sever 202 can be configured to: (i) determine respective first and second in-use color values, generated by the plurality of color MLAs 215, for each in-use point defined along the given in-use ray 925; (ii) determine respective first and second in-use SDF values, generated by the plurality of density MLAs 210, for each in-use point defined along the given in-use ray 925; (iii) determine, based on the respective first and second in-use SDF values, respective first and second in-use density values for each in-use point defined along the given in-use ray 925 as described above; and (iv) applying Equations (3) and (4) to the respective first and second in-use color values and the respective first and second in-use density values, determine the respective aggregate color value for the given ray 925.

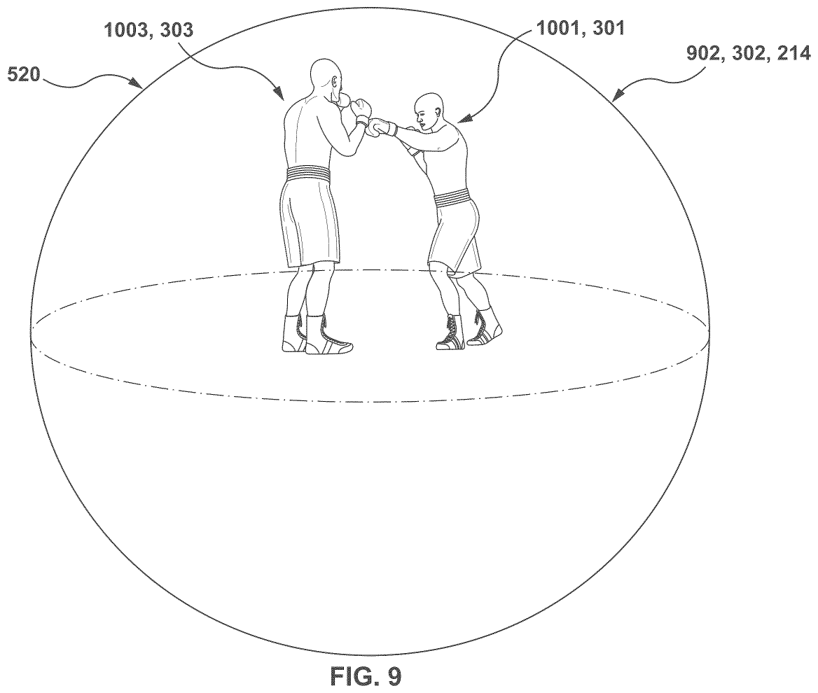

Thus, by using the plurality of density MLAs 210 and the plurality of color MLAs 215, the server 202 can be configured to determine respective in-use SDF value for each point along each ray of the 3D scene 902 and respective aggregated color values for each ray extending from each one of the first and second viewpoints 508, 510. By doing so, the server 202 can be configured to render a first 3D model 1001 of the first object 301 and a second 3D model 1003 of the second object 303, schematically depicted in FIG. 9, in accordance with certain non-limiting embodiments of the present technology.

Further, after rendering the first and second 3D models 1001, 1003 in the 3D scene 902, according to certain non-limiting embodiments of the present technology, the server 202 can be configured to transmit the 3D scene 902 as part of the given 3D animated video content 214 to the electronic device 204 for presentation of the 3D scene 902 to the user 206.

As it can be appreciated from a perspective onto the first and second 3D models 1001, 1003 illustrated in FIG. 9, by applying the embodiments of the present technology for determining the boundary between the first and second objects 301, 303 and colors values therefor, the overlap region 305 initially present in the given scene 302 has been accurately resolved in the 3D scene 902, thereby providing a more realistic representation of the first and second objects 301, 303. This may improve the user experience of the user 206 from viewing the given 3D animated video content 214 provided by the server 202.

### Method

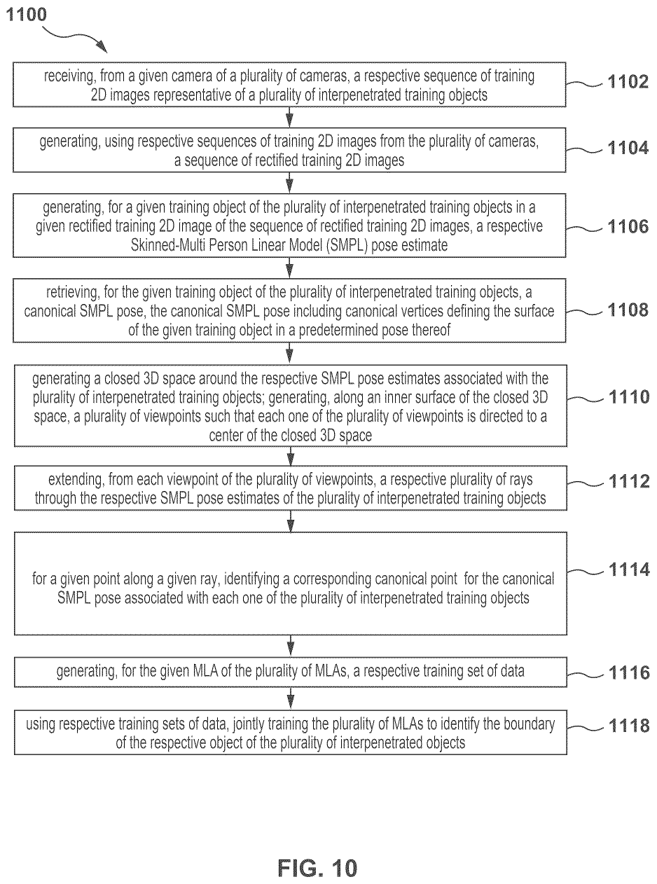

Given the architecture and the examples provided hereinabove, it is possible to execute a method for volumetric rendering of 3D scenes representative of a plurality of interpenetrated objects, such as the 3D scene 902 representative of the first and second object 301, 303 forming the overlap region 305 therebetween. With reference to FIG. 10, there is depicted a flowchart diagram of a method 1100, in accordance with certain non-limiting embodiments of the present technology. The method 1100 can be executed, for example, by the server 202.

As described in detail above, the method 1100 comprises training the plurality of density MLAs 210 and the plurality of color MLAs 215 to determine the respective SDF and color values, respectively, for the first and second objects 301, 303.

Step: 1102: Receiving, from a Given Camera of a Plurality of Cameras, a Respective Sequence of Training 2D Images Representative of a Plurality of Interpenetrated Training Objects

The method 1100 commences at step 1102 with the server 202 being configured to receive, from the plurality of cameras, such as the first and second camera 408, 410, the respective sequences of training 2D digital images representative of the given training scene 402, as described above with reference to FIG. 4.

As mentioned above, the plurality of cameras can be disposed along the inner surface of the imaginary sphere 420 and directed to the center if the imaginary sphere 420.

The method 1100 hence advances to step 1104.

Step 1104: Generating, Using Respective Sequences of Training 2D Images from the Plurality of Cameras, a Sequence of Rectified Training 2D Images

At step 1104, according to certain non-limiting embodiments of the present technology, the server 202 can be configured to generate, based on training images of the respective sequences of training 2D images taken at a same time, the sequence of rectified training 2D images, as described further above with reference to FIG. 4.

The method 1100 hence advances to step 1106.

Step 1106: Generating, for a Given Training Object of the Plurality of Interpenetrated Training Objects in a Given Rectified Training 2D Image of the Sequence of Rectified Training 2D Images, a Respective Skinned-Multi Person Linear Model (SMPL) Pose Estimate

Further, at step 1106, according to certain non-limiting embodiments of the present technology, based on the given rectified training 2D image 406, the server 202 can be configured to start rendering the training 3D scene 502. To do so, first, as described in detail above with reference to FIG. 5, the server 202 can be configured to generate, for each one of the first and training objects 401, 403, the first and second SMPL pose estimate 501, 503, respectively, representative of poses of the first and second training objects 401, 403 in the given rectified training 2D image 406.

The method 1100 thus proceeds to step 1108.

Step 1108: Retrieving, for the Given Training Object of the Plurality of Interpenetrated Training Objects, a Canonical SMPL Pose, the Canonical SMPL Pose Including Canonical Vertices Defining the Surface of the Given Training Object in a Predetermined Pose Thereof

At step 1108, according to certain non-limiting embodiments of the present technology, the server 202 can be configured to retrieve (or generate), for each one of the first and second training objects 401, 403, the respective training canonical SMPL pose representative of the first and second training objects 401, 403 in the predetermined poses thereof—such as the first training canonical SMPL pose 601 for the first training object 401, described above with reference to FIG. 6.

The method 1100 hence advances to step 1110.

Step 1110: Generating a Closed 3D Space Around the Respective SMPL Pose Estimates Associated with the Plurality of Interpenetrated Training Objects; Generating, Along an Inner Surface of the Closed 3D Space, a Plurality of Viewpoints Such that Each One of the Plurality of Viewpoints is Directed to a Center of the Closed 3D Space

At step 1110, according to certain non-limiting embodiments of the present technology, the server 202 can be configured to generate the closed 3D space 520 around the first and second training SMPL pose estimates 501, 503 including the first and second viewpoints 508, 510, as described in detail further above with reference to FIG. 5.

The method 1100 hence advances to step 1112.

Step 1112: Extending, from Each Viewpoint of the Plurality of Viewpoints, a Respective Plurality of Rays Through the Respective SMPL Pose Estimates of the Plurality of Interpenetrated Training Objects

At step 1112, according to certain non-limiting embodiments of the present technology, the server 202 can be configured to extend, from each one of the first and second viewpoints 508, 510, the respective plurality of rays through the first and second training SMPL pose estimates 501, 503, such as the given ray 525 extended from the first viewpoint 408. In some non-limiting embodiments of the present technology, the rays within the given plurality of rays can be equally spaced therebetween. However, this needs not be so in every embodiment of the present technology and the rays within the given plurality of rays can be arranged differently. In some other non-limiting embodiments of the present technology, the given plurality of rays emitted from the given one of the first and second viewpoints 508, 510, can comprise 2048 rays.

Further, according to certain non-limiting embodiments of the present technology, the server 202 can be configured to define, along the given ray 525, the plurality of points, such as the given point 530. In some non-limiting embodiments of the present technology, the plurality of points can be evenly distributed along the given ray 525. In some non-limiting embodiments of the present technology, the server 202 can be configured to define 64 points along the given ray 525.

The method 1100 hence advances to step 1114.

Step 1114: For a Given Point Along a Given Ray, Identifying a Corresponding Canonical Point for the Canonical SMPL Pose Associated with Each One of the Plurality of Interpenetrated Training Objects

At step 1114, according to certain non-limiting embodiments of the present technology, using Equation (1), the server 202 can be configured to identify, the corresponding canonical points along each one of the first training canonical SMPL pose 601 associated with the first training object 401 and along the second training canonical SMPL pose associated with the second training object 403.

The method 1100 hence advances to step 1116.

### Step 1116: Generating, for the Given MLA of the Plurality of MLAs, a Respective Training Set of Data

At step 1116, according to certain non-limiting embodiment of the present technology, the server 202 can be configured to generate the respective density training set of data for training each density MLA of the plurality of density MLAs 210.

More specifically, for the first density MLA associated with the first training object 401, the server 202 can be configured to generate the first density training set of data that includes the first plurality of density training digital objects, the given density training digital object of which includes: (i) coordinates of the corresponding canonical point in the coordinate system associated with the first training canonical SMPL pose 601; and (ii) the first training SMPL pose vector 505.

Similarly, for the second density MLA of the plurality of density MLAs 210, the server 202 can be configured to generate the second density training set of data including the second plurality of density training digital objects, the given one of which, for the given point 530 includes: (i) coordinates of the corresponding canonical point in the coordinate system associated with the second training canonical SMPL pose associated with the second training object 403; and (ii) the second training SMPL pose vector 507.

The method 1100 hence advances to step 1118.

### Step 1118: Using Respective Training Sets of Data, Jointly Training the Plurality of MLAs to Identify the Boundary of the Respective Object of the Plurality of Interpenetrated Objects

At step 1118, according to certain non-limiting embodiments of the present technology, the server 202 can be configured to use the respective density training sets of data generated at step 1116 for training each density MLA of the plurality of density MLAs 210.

More specifically, during the given training iteration, the server 202 is configured to: (1) feed the given density training digital object of the first plurality of density training digital objects to the first density MLA, thereby causing the first density MLA to generate the first predicted SDF value for the corresponding canonical point in the first training canonical SMPL pose 601; and (2) feed the given density training digital object of the second plurality of density training digital objects to the second density MLA, thereby causing the second density MLA to generate the second predicted SDF value for the corresponding canonical point in the second training canonical SMPL pose.

Further, the server 202 can be configured to apply the SDF loss function. According to certain non-limiting embodiments of the present technology, the SDF loss function is configured to penalize at least one of the first and second predicted SDF values in response to both: (i) the respective predicted SDF value being different from the respective ground truth SDF associated with a given density MLA of the plurality of density MLAs 210; and (ii) the respective predicted SDF value generated by the given density MLA being equal to the respective predicted SDF value generated by an other density MLA of the plurality of MLAs. In some non-limiting embodiments of the present technology, the SDF loss function can be expressed by Equation (2).

Further, in some non-limiting embodiments of the present technology, based on the respective predicted SDF values generated by the plurality of density MLAs 210, the server 202 can be configured to train the plurality of color MLAs 215 as described in detail above with reference to FIG. 5.

More specifically, similar to training the plurality of the density MLAs 210, the server 202 can be configured to generate, for each color MLA of the plurality of color MLAs 215, the respective color training set of data. For the first color MLA associated with the first training object 401, the server 202 can be configured to generate the first color training set of data that includes the first plurality of color training digital objects, the given color training digital object of which, for the given point 530, includes: (i) the coordinates of the corresponding canonical point of the first training canonical SMPL pose 601; (ii) the first training SMPL pose vector 505; and (iii) the respective label comprising the color value of the respective pixel 540 of the given rectified training 2D image 406 through which the given ray 525 extends.

Similarly, for training the second color MLA of the plurality of color MLAs 215, associated with the second training object 403, the server 202 can be configured to generate the second color training set of data including a second plurality of color training digital objects, a given one of which, for the given point 530, includes: (i) the coordinates of the corresponding canonical point of the second training canonical SMPL pose; (ii) the second training SMPL pose vector 507; and (iii) the respective label comprising the color value of the respective pixel 540 of the given rectified training 2D image 406 through which the given ray 525 extends.

Further, during a given training iteration of the plurality of color MLAs 215, the server 202 can be configured to feed the server 202 can be configured to feed, to each one of the plurality of color MLAs 215, the respective color training digital object associated with the given point 530, thereby causing each one of the plurality of color MLAs to generate the respective predicted color value for the corresponding canonical point associated with the respective training object. Further, during the same given iteration of the plurality of color MLAs 215, the server can be configured to: (i) receive respective predicted SDF values generated by the plurality of density MLAs 210 for each point defined along the given ray 525; (ii) determine, based on the respective predicted SDF values for the given point 530, respective density values; and (iii) based, on the respective density values and the respective predicted color values for each point along the given ray 525, determine the respective intermediate aggregated color value for the given ray 525.

Further, the server 202 can be configured to jointly train the plurality of color MLAs 215 by applying, during the given training iteration of the plurality of color MLAs 215, the color loss function that is configured to penalize the respective color predictions generated by each one of the plurality of color MLAs 215 for each point along the given ray 525 if the respective intermediate aggregated color value is different from the color value of the respective pixel 540 from the respective label of color training digital objects associated with the given ray 525. Also, as mentioned further above, in these embodiments, by applying the color loss function, the server 202 can be configured to additionally train each one of the plurality of density MLAs to determine the respective SDF values for the points along the rays.

Finally, after training each density MLA of the plurality of density MLAs 210 and each color MLA of the plurality of color MLAs 215m, the server 202 can be configured to use them for rendering the 3D scene 902 including the first and second 3D models 1001, 1003 of the first and second objects 301, 303, as described in detail above with reference to FIGS. 7 to 9. Further, in response to the 3D animation request 212, as described in detail above with reference to FIG. 2, the server 202 can be configured to transmit the 3D scene 902 with the first and second 3D models 1001, 1003 as part of the given 3D animated video content 214 to the electronic device 204 for presentation of the 3D scene 902 to the user 206.

The method 1100 hence terminates.

Thus, certain non-limiting embodiment of the present technology may allow more accurately determining the boundary between the first and second objects 301, 303, thereby resolving the overlap regions therebetween, such as the overlap region 305, which may allow generating the first and second 3D models 1001, 1003 that are more realistic and determine color values for the 3D models more accurately. This is believed to improve the user experience of the user 206 from viewing the given 3D animated video content 214.

It should be expressly understood that not all technical effects mentioned herein need to be enjoyed in each and every embodiment of the present technology.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A computer-implemented method for volume rendering of 3D scenes, the method comprising training a given machine-learning algorithm (MLA) of a plurality of MLAs to identify a boundary between a plurality of interpenetrated objects to be rendered in a given 3D scene, the training comprising:
receiving, from a given camera of a plurality of cameras, a respective sequence of training 2D images representative of a plurality of interpenetrated training objects;
generating, using respective sequences of training 2D images from the plurality of cameras, a sequence of rectified training 2D images;
generating, for a given training object of the plurality of interpenetrated training objects in a given rectified training 2D image of the sequence of rectified training 2D images, a respective Skinned-Multi Person Linear Model (SMPL) pose estimate, the respective SMPL pose estimate including:
pose vertices defining a surface of the given training object in a respective pose thereof in the given rectified training 2D image; and
a respective SMPL pose vector comprising values of a plurality of SMPL pose parameters representative of the respective pose of the given training object in the given rectified training 2D image;
retrieving, for the given training object of the plurality of interpenetrated training objects, a canonical SMPL pose, the canonical SMPL pose including canonical vertices defining the surface of the given training object in a predetermined pose thereof;
generating a closed 3D space around the respective SMPL pose estimates associated with the plurality of interpenetrated training objects;
generating, along an inner surface of the closed 3D space, a plurality of viewpoints such that each one of the plurality of viewpoints is directed to a center of the closed 3D space;
extending, from each viewpoint of the plurality of viewpoints, a respective plurality of rays through the respective SMPL pose estimates of the plurality of interpenetrated training objects;
for a given point along a given ray, identifying a corresponding canonical point in the canonical SMPL pose associated with each one of the plurality of interpenetrated training objects;
generating, for the given MLA of the plurality of MLAs, a respective training set of data,
the respective training set of data including a plurality of training digital objects, a given one of which, for the given point along the given ray comprises: (i) coordinates of the corresponding canonical point associated with the respective training object; and (ii) the respective SMPL pose vector associated with the respective training object;
using respective training sets of data, jointly training the plurality of MLAs to identify the boundary of the respective object of the plurality of interpenetrated objects, by:
feeding respective training digital objects associated with the given point to each MLA of the plurality of MLAs, thereby causing each one of the plurality of MLAs to generate a respective predicted signed distance field (SDF)value for the corresponding canonical point; and
applying an SDF loss function, the SDF loss function being configured to penalize the respective predicted SDF value of the given point generated by the given MLA in response to the respective predicted SDF value generated by the given MLA being equal to the respective predicted SDF value generated by an other MLA of the plurality of MLAs.

2. The method of claim 1, wherein the closed 3D space comprises a sphere defined around the given training 3D scene; and wherein each one of the plurality of viewpoints is disposed along an inner surface of the sphere.

3. The method of claim 1, wherein the plurality of viewpoints comprises two oppositely facing viewpoints directed to a center of the closed 3D space.

4. The method of claim 1, wherein the respective plurality of rays from a given viewpoint of the plurality of viewpoints are equally spaced therebetween.

5. The method of claim 1, further comprising identifying the given point along the given ray, the identifying comprises identifying, along the given ray, a plurality of points including a predetermined number of points uniformly distributed along the given ray.

6. The method of claim 1, wherein the identifying the corresponding canonical point comprises applying an SMPL-based Linear Blend Skinning algorithm.

7. The method of claim 6, wherein the applying is in accordance with a following equation:
$${x}^{c} = {( {\sum }_{i = 1}^{{n}_{b}} {w}_{i}^{d} {B}_{i} )}^{- 1} {x}^{d} ,$$
where x^{c} is the corresponding canonical point associated with the given training object;
x^{d} is the given point along the given ray;
Bᵢ is a transformation matrix associated with a joint jᵢ of the given training object, the transformation matrix having been generated based on the respective SMPL pose estimate associated with the given training object;
n_{b} is a number of joints of the given training object; and
w^{d}ᵢ is a function indicative of a weight distribution across a skinning process, the weight distribution having been determined based on coordinates of a respective vertex of the respective SMPL pose estimate associated with the given training object that is closest to the given point.

8. The method of claim 1, wherein the SDF loss functions is expressed by a following equation:
$${L}_{SDF} = \frac{1}{( \begin{matrix}N \\ 2\end{matrix} )} {\sum }_{p = 1}^{P} {\sum }_{k = p + 1}^{P} {\sum }_{i = 1}^{N * P} \text{?} ( {s}_{i}^{k} , {s}_{i}^{p} ) {s}_{i}^{k} \cdot {s}_{i}^{p} ,$$
$$\text{?} \text{indicates text missing or illegible when filed}$$
where P is a number of training objects in the plurality of interpenetrated training objects;
$$( \begin{matrix}N \\ 2\end{matrix} )$$
(is a number of unique pairs of training objects within the plurality of interpenetrated training objects;
sᵢ^{k} is the respective predicted SDF value for the given point generated by a first one of the plurality of MLAs, associated with a first training object of the plurality of interpenetrated training objects; and
sᵢ^{p} is the respective predicted SDF value for the given point generated by a second one of the plurality of MLAs, associated with a second training object of the plurality of interpenetrated training objects.

9. The method of claim 1, wherein:
the feeding respective training digital objects associated with the given point to each MLA of the plurality of MLAs further causes each one of the plurality of MLAs to generate a respective SDF vector embedding for the corresponding canonical point;
the training the plurality of MLAs comprises training the plurality of MLAs in concert with training a second plurality of MLAs to determine color values for the plurality of interpenetrated objects to be rendered in the given 3D scene,
the training the second plurality of MLAs comprising:
receiving, at a current training iteration, from each one of the plurality of MLAs, respective predicted SDF values for the corresponding canonical point associated with the given point;
determining, based on the respective predicted SDF values, current predicted density values for the corresponding canonical point;
generating, for an other given MLA of the second plurality of MLAs, a respective other training set of data including an other plurality of training digital objects, a given one of which, for the given point along the given ray includes: (i) the coordinates of the corresponding canonical point associated with the respective training object associated with the other given MLA; (ii) the respective SDF vector embedding for the corresponding canonical point associated with the respective training object; and (iii) a respective label representative of a color value of a pixel of the given rectified training 2D image associated with the given ray; and
feeding respective training digital objects from each respective other training set of data each MLA of the second plurality of MLAs associated with the given point, thereby causing each one of the second plurality of MLAs to generate a respective predicted color value for the corresponding canonical point associated with the respective training object;
determining, based on respective predicted color values generated by each one of the second plurality of MLAs and the current predicted density values generated by the plurality of MLAs for each point of the given ray, a respective intermediate aggregated color value for the given ray at the current training iteration; and
applying a color loss function, the color loss function being configured to penalize the respective intermediate aggregated color value in response to the respective intermediate color aggregation value being different from the color label of the respective label.

10. The method of claim 9, wherein the determining the respective intermediate aggregated color value comprises determining the respective aggregated color value according to a following equation:
$${C}_{r} = {\sum }_{p = 1}^{P} {\sum }_{i = 1}^{N * P} {w}_{i}^{p} \cdot {c}_{i}^{p} + {bg}_{r} ,$$
where c^{p}ᵢ is the respective predicted color value for the corresponding canonical point, associated with the respective object p generated by the given MLA of the second plurality of MLAs;
w^{p}ᵢ is a respective weight value determined for the respective predicted color value based on the current predicted density values; and
bgᵣ is a background color associated with the given ray.

11. The method of claim 10, further comprising determining the respective weight value according to a following equation:
$${w}_{i}^{p} = ( 1 - exp ( Δ {x}_{i} {σ}_{i}^{p} ) ) \cdot exp ( - {\sum }_{j = 1}^{i} Δ {x}_{i} \cdot {\sum }_{k = 1}^{P} {σ}_{i}^{k} ) ,$$
where Δxᵢ is a length of a segment between the given point and a sequentially following point along the given ray; and
σ^{p}ᵢ is a given current predicted density value, generated by a respective MLA of the plurality of MLAs, associated with the given training object, based on the respective SDF value.

12. The method of claim 9, wherein the determining the current predicted density values for the corresponding canonical point comprises applying, to each one of the respective predicted SDF values, a scaled Laplace distribution's Cumulative Distribution Function.

13. The method of claim 9, wherein, prior to the generating the respective other training set of data, the method further comprises sampling, in the plurality of points of the given ray, a set of points for training the second plurality of MLAs within regions of a maximum density of the respective training object.

14. The method of claim 13, wherein the sampling comprises applying an importance sampling algorithm, the importance sampling algorithm being configured to generate, along the given ray, points representative of each one of the plurality of interpenetrated training objects through which the given ray extends.

15. The method of claim 14, further comprising combining, along the given ray, points representative of each one of the plurality of interpenetrated training objects through which the given ray extends.

16. The method of claim 14, wherein the importance sampling algorithm comprises an opacity function.

17. The method of claim 9, further comprising using the plurality of MLAs for identifying the boundary between the plurality of interpenetrated objects to be rendered in the given 3D scene, the using including:
receiving, from the given camera of the plurality of cameras, a respective in-use sequence of 2D images representative of the plurality of interpenetrated objects;
generating, using respective in-use sequences of 2D images from the plurality of cameras, a sequence of in-use rectified 2D images;
generating, for the given object of the plurality of interpenetrated objects in a given in-use rectified 2D image of the sequence of in-use rectified 2D images, a respective in-use SMPL pose estimate, the respective in-use SMPL pose estimate including:
in-use pose vertices defining the surface of the given object in the respective pose thereof in the given in-use rectified 2D image; and
the respective in-use SMPL pose vector comprising values of the plurality of SMPL pose parameters representative of the respective pose of the given object in the given in-use rectified 2D image;
retrieving, for the given object of the plurality of interpenetrated objects, an in-use canonical SMPL pose, the in-use canonical SMPL pose including in-use canonical vertices defining the surface of the given object in the predetermined pose thereof;
generating the closed 3D space around the respective in-use SMPL pose estimates associated with the plurality of interpenetrated objects, the closed 3D space including the plurality of viewpoints generated along the inner surface thereof;
extending, from each viewpoint of the plurality of viewpoints, the respective plurality of rays through the respective in-use SMPL pose estimates;
for the given point along the given ray, identifying a corresponding in-use canonical point for the in-use canonical SMPL pose associated with each one of the plurality of interpenetrated objects;
generating, for the given MLA, associated with the respective object of the plurality of interpenetrated objects, a given in-use digital object, including: (i) coordinates of the in-use corresponding canonical point associated with the respective object; and (ii) the respective SMPL pose vector associated with the respective object;
feeding the given in-use digital object to the given MLA of the plurality of MLAs, thereby causing the given MLA to determine a respective in-use SDF value for the corresponding canonical point; and
based on respective in-use SDF values at the corresponding canonical point generated by each one of the plurality of MLAs, determining whether a surface of the given object extends through the given point.

18. The method of claim 17, wherein:
the feeding the given in-use digital object to the given MLA of the plurality of MLAs further causes the given MLA to generate a respective in-use SDF vector embedding for the corresponding canonical point associated with the respective object; and
the using further comprises using the second plurality of MLAs for determining the color values for each one of the plurality of interpenetrated objects, by:
determining, based on each respective in-use SDF value at the corresponding canonical point, generated by the plurality of MLAs, a respective density value at the corresponding canonical point;
generating a given in-use color digital object including: (i) coordinates of the in-use corresponding canonical point associated with the respective object; and (ii) respective in-use SDF vector embedding for the corresponding canonical point;
feeding, to the other given MLA of the second plurality of MLAs associated with the respective object, the given in-use color digital object, thereby causing the other given MLA to generate a respective color value for the corresponding canonical point of the respective object;
determining, based on respective density values generated by the plurality of MLAs and respective color values generated by the second plurality of MLAs for the corresponding canonical point, a respective aggregated color value for the given ray; and
using the respective aggregated color value for the volume rendering of the plurality of interpenetrated objects on the given 3D scene.

19. A server for volume rendering of 3D scenes, the server comprising at least one processor and at least one non-transitory memory storing executable instructions, which, when executed by the at least one processor, cause the server to train a given machine-learning algorithm (MLA) of a plurality of MLAs to identify a boundary between a plurality of interpenetrated objects to be rendered in a given 3D scene, by:
receiving, from a given camera of a plurality of cameras, a respective sequence of training 2D images representative of a plurality of interpenetrated training objects;
generating, using respective sequences of training 2D images from the plurality of cameras, a sequence of rectified training 2D images;
generating, for a given training object of the plurality of interpenetrated training objects in a given rectified training 2D image of the sequence of rectified training 2D images, a respective Skinned-Multi Person Linear Model (SMPL) pose estimate, the respective SMPL pose estimate including:
pose vertices defining a surface of the given training object in a respective pose thereof in the given rectified training 2D image; and
a respective SMPL pose vector comprising values of a plurality of SMPL pose parameters representative of the respective pose of the given training object in the given rectified training 2D image;
retrieving, for the given training object of the plurality of interpenetrated training objects, a canonical SMPL pose, the canonical SMPL pose including canonical vertices defining the surface of the given training object in a predetermined pose thereof;
generating a closed 3D space around the respective SMPL pose estimates associated with the plurality of interpenetrated training objects;
generating, along an inner surface of the closed 3D space, a plurality of viewpoints such that each one of the plurality of viewpoints is directed to a center of the closed 3D space;
extending, from each viewpoint of the plurality of viewpoints, a respective plurality of rays through the respective SMPL pose estimates of the plurality of interpenetrated training objects;
for a given point along a given ray, identifying a corresponding canonical point for the canonical SMPL pose associated with each one of the plurality of interpenetrated training objects;
generating, for the given MLA of the plurality of MLAs, a respective training set of data,
the respective training set of data including a plurality of training digital objects, a given one of which, for the given point along the given ray comprises: (i) coordinates of the corresponding canonical point associated with the respective training object; and (ii) the respective SMPL pose vector associated with the respective training object;
using respective training sets of data, jointly training the plurality of MLAs to identify the boundary of the respective object of the plurality of interpenetrated objects, by:
feeding respective training digital objects associated with the given point to each MLA of the plurality of MLAs, thereby causing each one of the plurality of MLAs to generate a respective predicted signed distance field (SDF)value for the corresponding canonical point; and
applying an SDF loss function, the SDF loss function being configured to penalize the respective predicted SDF value of the given point generated by the given MLA in response to the respective predicted SDF value generated by the given MLA being equal to the respective predicted SDF value generated by an other MLA of the plurality of MLAs.

20. The server of claim 19, wherein:
the feeding respective training digital objects associated with the given point to each MLA of the plurality of MLAs further causes each one of the plurality of MLAs to generate a respective SDF vector embedding for the corresponding canonical point; and
the executable instructions cause the server to train the plurality of MLAs comprises training the plurality of MLAs in concert with training a second plurality of MLAs to determine color values for the respective object of the plurality of interpenetrated objects to be rendered in the given 3D scene, by:
receiving, at a current training iteration, from each one of the plurality of MLAs, respective predicted SDF values for the corresponding canonical point associated with the given point;
determining, based on the respective predicted SDF values, current predicted density values for the corresponding canonical point;
generating, for an other given MLA of the second plurality of MLAs, a respective other training set of data including an other plurality of training digital objects, a given one of which, for the given point along the given ray includes: (i) the coordinates of the corresponding canonical point associated with the respective training object associated with the other given MLA; (ii) the respective SDF vector embedding for the corresponding canonical point associated with the respective training object; and (iii) a respective label representative of a color value of a pixel of the given rectified training 2D image associated with the given ray; and
feeding respective training digital objects from each respective other training set of data each MLA of the second plurality of MLAs associated with the given point, thereby causing each one of the second plurality of MLAs to generate a respective predicted color value for the corresponding canonical point associated with the respective training object;
determining, based on respective predicted color values generated by each one of the second plurality of MLAs and the current predicted density values generated by the plurality of MLAs for each point of the given ray, a respective intermediate aggregated color value for the given ray at the current training iteration; and
applying a color loss function, the color loss function being configured to penalize the respective intermediate aggregated color value in response to the respective intermediate color aggregation value being different from the color label of the respective label.
